(19) United States
(12) Patent Application Publication
(10) Pub. No.: US 2004/0026268 A1
(43) Pub. Date: Feb. 12, 2004

(54) Gas sensor and detection method and device for gas.concentration

(76) Inventors: Masao Maki, Nabari-shi (JP); Katsuhiko Uno, Nara-shi (JP); Takashi Niwa, Ikoma-gun (JP); Kunihiro Tsuruda, Kashihara-shi (JP); Takahiro Umeda, Nara-shi (JP); Makoto Shibuya, Yamatokoriyama-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/433,572

(22) PCT Filed: Dec. 7, 2001
(86) PCT No.: PCT/JP01/10720

(30) Foreign Application Priority Data
Dec. 7, 2000 (JP) 2000-372621

(51) Int. Cl. G01N 27/26

(52) U.S. Cl. 205/784; 204/426; 204/431; 204/427

(57) ABSTRACT

To provide a gas sensor and a method of sensing the gas concentrations which are capable of a battery drive through low power consumption and highly reliable, the gas sensor in which an electromotive force type gas sensor element is formed on a substrate, wherein the electromotive force type gas sensor element has a heating element formed on the substrate, a layer of solid electrolyte formed with an insulating layer interposed on the heating element and two electrodes formed on the solid electrolyte and is characterized in that the substrate is a heat-resistant glass base substrate.

### FIELD OF THE INVENTION

The main object of the present invention relates to a gas sensor incorporated into an alarm of flammable gas such as carbon monoxide, which is used in ordinary households, and this gas sensor is intended to apply to a battery-driven type sensor with a high degree of flexibility in installation. Further, it is aimed at a highly reliable and power-saving type sensor in being applied for the purpose of gas alarm.

### PRIOR ART

As gases desired to be detected from the viewpoint of safety and feeling of security in order to realize comfortable life in homes, there can be given methane or propane due to fuel gas leakage, or carbon monoxide due to incomplete combustion.

With respect to carbon monoxide, since there have not been conventionally proposed reliable and long-life gas sensors used in ordinary households for the purpose of incomplete combustion alarm and it is difficult to reduce the accidents, carbon monoxide detecting sensors being low power consumption types, which can be freely installed in the rooms to use and driven with batteries, and are low-cost, compact and highly reliable, are extremely desired.

As gas sensor conventionally proposed, in particular, chemical sensor for detecting flammable gas like carbon monoxide, there are known a method of sensing the concentration of carbon monoxide from current values proportional to the concentration of carbon monoxide by providing-an electrode absorbing and oxidizing carbon monoxide in an electrolytic solution (potentiostatic electrolysis type gas sensor), a method of sensing gas by using n-type semiconductor oxides, which are sensitized through addition of a small amount of metal elements such as noble metals, for example, a sintered material such as tin oxide and making use of a characteristic that when these semiconductors contact with flammable gases, their electric conductivity varies (semiconductor type gas sensor), and a method of detecting the difference of the heating value when a pair of comparison elements, which are formed by supporting noble metal and without supporting noble metal, using a platinum fine wire, provided with alumina, of about 20 μm in thickness, are heated to a definite temperature and flammable gases contact with these elements to perform catalytic oxidation reaction (catalytic combustion type gas sensor). For example, (literature 1) “Sensor Practical Dictionary” under the editorship of Toyoaki Omori: “Chapter 14: Basics of Gas Sensor” (Masatake Haruta) p 112-130 (1986) by Fujitec Corporation.

And, there is also proposed an electromotive force type solid electrolyte carbon monoxide sensor which detects carbon monoxide by constructing a zirconia electrochemical cell and forming a platinum-alumina catalyst layer on one side of electrodes. (For example, refer to H. OKAMOTO, H. OBAYASI AND T. KUDO, Solid State Ionics, 319(1980)

The principle of this solid electrolyte type carbon monoxide sensor is based on the fact that a kind of oxygen concentration cell is formed on the electrode of the catalyst layer side and the bare electrode, and utilizes the fact that in the electrode of the catalyst layer side, oxygen reaches the electrode as it is and carbon monoxide does not reach the electrode while in the bare electrode, both oxygen and carbon monoxide reach the electrode and this carbon monoxide reduces the oxygen to form an oxygen concentration cell between both electrodes and therefore the output of electromotive force arises.

Any of these chemical sensors has the following defects. That is, there is a problem that any of potentiostatic electrolysis gas sensor, semiconductor type gas sensor and catalytic combustion type gas sensor is hard to introduce into mass-production process of uniform quality from the viewpoint of its constitution and low in yield, and therefore the cost becomes high.

And, in any sensor, it is required to increase temperature for its operation and considerable driving energy is required for this purpose. For example, in semiconductor type gas sensors, there are essentially repeated operations in measurement temperatures consisting of operations on the high-temperature side and the low-temperature side, and heating of the order of at least 500° C. is required regardless of the kind of gas to be measured during the high-temperature operations. This involves high energy consumption and it becomes a significant burden for a battery drive in need of saving power.

Though it is also conceivable to reduce the thickness of sensors or downsize sensors to save the power consumption, it is difficult to realize low power consumption by doing so because electric power consumed to heat air around a sensor contributes to a large portion of the power consumption.

As essential requirements for gas sensors used in ordinary households, there are required battery-driven gas sensors with a high degree of flexibility in installation, which are low power consumption types, less in wrong alarms and highly reliable, and low-cost.

Further, chemical sensors have issues in durability on the whole. That is, there is an issue of deterioration of the sensor sensitivity with time. The reason for this is that electrodes or catalysts, which take charge of central functions of the chemical sensors, deteriorate as reactions proceed with time and that these deterioration result from reduction of catalysts by hydrocarbon base reducing gases which exist in trace amounts in the atmosphere or inhibition of reactions for detecting carbon monoxide due to strong adsorption of sulfuric compounds on the surfaces of electrodes. Particularly, in recent years, various silicon compounds are used broadly in housewares and the deterioration of the gas sensor due to this silicone oligomer becomes a large issue.

### SUMMARY OF THE INVENTION

Therefore, it is an object of the present invention to provide a gas sensor and a method of sensing the gas concentrations, which are capable of a battery drive through low power consumption and highly reliable.

To achieve the above objectives, a gas sensor of the present invention is a gas sensor, in which an electromotive force type gas sensor element is formed on a substrate, wherein the electromotive force type gas sensor element has a heating element formed on the substrate, a layer of solid electrolyte formed with an insulating layer interposed on the heating element and two electrodes formed on the solid electrolyte and is characterized in that the substrate is a heat-resistant glass base substrate.

The gas sensor, constructed as described above, according to the present invention is characterized, particularly, by using a heat-resistant glass base substrate which is superior in heat resistance and low in thermal conductivity as substrate, and this allows battery drive and saves power consumption.

That is, the gas sensor according to the present invention, as described in detail later, provides the constitution capable of detecting gas at extremely low power consumption by enabling cyclic pulsed heating involving rapid heating and cooling by means of the high heat resistance of the heat-resistant glass base substrate and by preventing the heat from being released through the substrate in an efficient manner by means of the low thermal conductivity of the heat-resistant glass base substrate to enable to efficiently heat the electromotive force type gas sensor section which needs a relatively high temperature in detecting gas.

In the gas sensor, constructed as described above, according to the present invention, a porous oxidation catalyst layer may be formed on the one electrode of the two electrodes.

And, in above-mentioned the gas sensor, the two electrodes may be composed of materials identical with each other.

Further, in the gas sensor according to the present invention, the two electrodes may be formed with a first electrode and a second electrode which are mutually different in the oxygen adsorption capacity.

In addition, in a gas sensor according to the present invention, the heat-resistant glass base substrate is preferably one selected from the group consisting of quartz substrate, crystalline glass substrate and glazed ceramic substrate.

Furthermore, in a gas sensor according to the present invention, preferably, the heating element consists of platinum base metal thin films.

Further, in the gas sensor, a Ti thin film or a Cr thin film with a film thickness of 25 Å to 500 Å is preferably formed between the heat-resisdtant glass base substrate and the heating element. And, in a gas sensor according to the present invention, 2 or more above-mentioned electromotive force type gas sensor elements may be provided on the substrate.

Furthermore, in a gas sensor according to the present invention, a resistance film for detecting temperature may be further formed on the substrate.

Furthermore, in a gas sensor according to the present invention, a semiconductor type gas sensor element may be further formed on the substrate.

And, a method of sensing the gas concentrations according to the present invention is a method of sensing the gas concentrations with a gas sensor element which includes a heating element and is capable of outputting signals, corresponding to the gas concentration which is detected at a temperature above a predetermined temperature, and is characterized in that in order to realize the battery operations required for saving power, the method comprises:

bringing a temperature of the gas sensor element to the predetermined temperature or higher at least for a definite time of period straddling the time of interruption of the pulsed voltage by applying a pulsed voltage to the heating element periodically; and

detecting signals output by the gas sensor element within the definite time of period.

In the method of sensing the gas concentrations according to the present invention described above, it is preferred to detect the gas concentration based on an average of the electromotive force values exhibited by the electromotive force type gas sensor within an arbitrary minute time of period on either side antecedent to or after the time of interruption of the pulsed voltage to the heating element.

And, in the a method of sensing the gas concentrations according to the present invention, when the gas sensor element is an electromotive force type gas sensor element provided with a solid electrolyte layer and a first electrode and a second electrode formed on the solid electrolyte of the solid electrolyte layer, respectively, which are mutually different in the oxygen adsorption capacity, the gas sensor element detects the electromotive force differentials between the first electrode and the second electrode as signals corresponding to the gas concentration, which is output from the gas sensor element within the definite time of period.

And, in the a method of sensing the gas concentrations according to the present invention, when the gas sensor is an electromotive force type gas sensor element provided with a solid electrolyte layer, a pair of electrodes formed on the solid electrolyte layer, and a porous oxidation catalyst layer formed on the one electrode of a pair of electrodes, the gas sensor element detects the potential of the one electrode relative to the other electrode as signals corresponding to the gas concentration, which is output from the gas sensor element within the definite time of period.

And, a gas detecting apparatus according to the present invention is characterized in that the gas detecting apparatus comprises an electromotive force type gas sensor formed with an insulating layer interposed on the heat-resistant glass base substrate including a heating element, a power supply means which supplies electric power to the heating element, a power control means of controlling the power applied to the heating element, a detection means of the electromotive force signals of the gas sensor and a signal control means.

Further, another gas detecting apparatus according to the present invention is characterized in that the gas detecting apparatus comprises an electromotive force type gas sensor section formed with an insulating layer interposed on the heat-resistant glass base substrate in the form of a plate, including a heating element, a power supply means which supplies electric power to the heating element, a power control means of controlling the power applied to the heating element, a detection means of the electromotive force signals of the gas sensor, a signal control means and an alarm-notifying means alarming in recognizing with a comparison means that the concentration of the gas to be detected is equal to or higher than the predetermined reference concentration.

The gas sensors according to the present invention, and the gas sensors used in the methods or the apparatus according to the present invention, which have been respectively described above, have further the following features.

That is, since the gas sensor has the constitution described above, it has the constitution which can be essentially manufactured at low cost and can realize low power consumption and even enables downsizing. That is, this gas sensor has a characteristic that since the gas sensor detects the potential difference, which is based on the difference between-chemical potentials corresponding to the difference between the gas concentrations, through the two electrodes on the solid electrolyte, downsizing the sensor as manufacturing technique allows does not affect the function of detecting the gas concentration.

Further, since the gas sensor can be fabricated by applying micro-processing technique, which is fundamental process technique for manufacturing semiconductor, to the surface of the substrate in the form of a plate, a plurality of sensor functions can be readily integrated on the single substrate as required by separating respective functional thin films and stacking respectively.

Hereinafter, the operation of gas-detection of the gas sensor according to the present invention is described.

Incidentally, since the gas sensor according to the present invention can be separated into a first gas sensor having a porous catalyst layer and a second gas sensor not having a porous catalyst layer from the viewpoint of operation thereof, the operations of both sensors are described.

In the constitution of the first gas sensor, the solid electrolyte element formed on the substrate is heated to a temperature of 250° C. to 500° C. required for its operation by pulsed energization to the heating element. In this case, the temperature required for solid electrolyte element in order to operate it so as to attain an electromotive force type output varies depending on kinds of solid electrolyte, electrode and porous catalyst. In this gas sensor, since there is used the heat-resistant glass base substrate having a characteristic of being resistant to thermal shock with a thermal shock resistance coefficient of 200° C. or higher, the sensor has a characteristic that the substrate is capable of resisting the thermal shock even if the heating element is heated by a momentary energization. On the other hand, the solid electrolyte section is hard to generate thermal stress and resistant to thermal shock because it can be constituted of a thin film. Further, since the substrate of this kind is also made of a thermally low conductive material, it can suppress the release of heat through the substrate, and therefore it has an advantageous characteristic that the heat generated by the pulsed energization can be efficiently transferred to the element section formed on the substrate. That is, the basic principle for saving power in the present invention is a concept of reducing energy loss due to the unnecessary heating of air or the substrate while securing the energy to bring the sensor to a temperature required for the operation of a solid electrolyte element of an electromotive force type by pulsed driving of applying a voltage to the heating element only during an adequately short time, for example, several milliseconds (by inputs to the heating element for an adequately short time of period, for example, several milliseconds of period).

Though an issue is whether information corresponding to the concentration of gas to be detected can be actually attained from the solid electrolyte element of an electromotive force type by means of the short energy-input of the order of several milliseconds, the inventor et al. verified that the gas concentrations can be adequately detected through the constitution of the present invention. Specifically, the detection was possible by inputting the power in pulse form to the heating element repeatedly and by collecting the average of the electromotive force values exhibited by the electromotive force type gas sensor in the form of a time series and in order within an arbitrary minute time of period on either side antecedent to or after the time of interruption of the power.

This timing of collecting data is set within a definite time of period when the temperature required for the operation of the solid electrolyte element is retained. Thus, the inventor et al. found that by collecting the average of the electromotive force values exhibited by the electromotive force type gas sensor in the form of a time series, the change in gas concentrations in the ambient where the sensor is placed could be adequately detected, based on the data collected being discontinuous and discrete. Conventionally, there have been no cases of obtaining the information of the gas concentration by repeating the operation by pulsed driving on the order of milliseconds like this in the electromotive force type gas sensor adopting the solid electrolyte.

Though an impedance between both electrodes on the solid electrolyte is high because of low temperature and signals are buried in noise immediately after energization to the heating element, temperature of each element of the solid electrolyte element is raised with energization and an output voltage based on the electromotive force corresponding to the gas concentration arises with increase in temperature. When a temperature boot operation is repeated at an adequate energization timing and at adequate intervals and the output of the electromotive force between both in an arbitrary minute time of period electrodes is collected within a period when the temperature of the solid electrolyte is increased or decreased and is equal to or higher than a definite temperature, the output value of the electromotive force retains a constant value in the case where the concentration of the gas to be detected is zero but it increases in relation to the concentration value of the gas to be detected in the case of increase in the concentration of the gas to be detected. Thereby, the operation of the gas sensor, i.e., the operation of battery driving of extremely low power consumption becomes possible.

Hereinafter, the basic operations as a gas sensor are described. Even though the operations are pulsed operations of a short time, the basic operation principle thereof are considered to be not so different from that of the conventional balanced operations. Since an insulating film is formed on the surface of the heating element, there is not a possibility that electrons flow into or react with the solid electrolyte, and the field effect of the heating element appears in the sensor output.

By energization to the heating element and heating, a solid electrolyte, a pair of electrodes formed on the surface thereof and a porous oxidation catalyst layer formed on the surface of the one electrode of a pair of electrodes become sufficient working conditions for exerting their functions. The sensor is in such a working condition while the solid electrolyte element reaches a certain temperature required for the operation thereof or a higher temperature, and this condition is realized either at end point of the duration provided with energy, i.e., immediately before energy input is stopped or on the way where the element is cooled from a maximum temperature immediately after input is stopped. Therefore, when the power is input to the heating element in pulse form repeatedly to operate it periodically, timing to collect data is within an arbitrary minute time of period on either side antecedent to or after the time of interruption of the intermittent pulsed energyzation to the heating element. In this situation, the porous catalyst layer has the functions of allowing oxygen to permeate to the electrode section well and the reducing gas like carbon monoxide not to permeate to the electrode section by oxidizing it perfectly. Thereby, when the sensor is used in the atmosphere, the electrode covered with the porous catalyst layer acts as a reference electrode which always retains the substantially constant oxygen concentration (the oxygen concentration does not depend on the existence of carbon monoxide).

In working conditions, the electromotive force is not generated between electrodes when the sensor is placed in an atmosphere of air not containing the gas to be detected like carbon monoxide because the concentrations of oxygen (oxygen concentrations at the respective electrode surfaces) reaching each electrode of a pair of electrodes are almost equivalent. On the other hand, in an atmosphere of air containing the gas to be detected like carbon monoxide, while the same oxygen concentration as the case of not containing carbon monoxide is retained at the electrode provided with a porous catalyst layer, the oxygen concentration becomes less at the bare electrode not being provided with a porous catalyst layer because the reducing gas like carbon monoxide reaches the surface of the electrode and therefore reduces the oxygen adsorbed on the surface of the electrode. Therefore, the difference between chemical potentials corresponding to the difference between the oxygen concentrations is produced between both electrodes and the electromotive force resulting from the difference between chemical potentials is generated between both electrodes. Since this electromotive force shows the dependence on the concentration of carbon monoxide, which is not necessarily Nernst type, in some operating conditions but exhibits the output values of electromotive force uniquely corresponding to the concentration of carbon monoxide, the concentration of carbon monoxide can be sensed from the output of electromotive force.

Next, a second gas sensor of the present invention is described.

However, a description of pulsed operations in the second gas sensor of the invention is omitted herein because those are similar to that in the first gas sensor. A solid electrolyte element is heated to a temperature of 250° C. to 500° C. required for its operation by energization to a heating element. Since an insulating film is formed on the surface of the heating element, there is not a possibility that electrons flow into or react with the solid electrolyte, and the field effect of the heating element appears in the sensor output. The solid electrolyte and the first electrode and the second electrode formed on the surface of the solid electrolyte become working conditions by the energization to a heating element and heating. The first electrode and the second electrode are constituted of substances which are mutually different in the adsorption capacities of oxygen and carbon monoxide and the catalytic oxidation capacity of carbon monoxide.

In this working condition, when the sensor is placed in an atmosphere of air not containing the gas to be detected like carbon monoxide, the oxygen concentrations reaching the electrodes and solid electrolyte interfaces exhibit the electromotive force outputs corresponding to the difference between the oxygen-adsorption capacities of the respective electrodes and the difference between the diffusion abilities into three-phase interfaces which are sections for taking in oxygen of the solid electrolyte. This point is set as zero point (reference point). This point is determined by the combination of the first electrode and the second electrode used.

On the other hand, in an atmosphere of air containing the gas to be detected like carbon monoxide, the electromotive force difference, which corresponds also to the concentration of carbon monoxide, is generated in addition to the adsorption characteristics and the catalytic oxidation capacities of respective gases of the first electrode and the second electrode, and it shows output value which deviates by the difference between the outputs based on the oxygen concentrations at the respective electrodes, which relates to the concentration of carbon monoxide, from the output of the balanced electromotive force in air not containing carbon monoxide. Though this difference between the outputs from the reference point becomes positive or negative depending on how to combine the electrodes, in either case, the absolute value of the difference between the outputs from the point defined as zero point is the value relating to the concentration of carbon monoxide. Accordingly, the concentration of the gas to be detected like carbon monoxide is determined from this absolute value of the difference between the outputs and an alarm operation becomes possible when the concentration of carbon monoxide exceeds the predetermined concentration. With respect to the operation as a gas sensor, examples of detecting carbon monoxide have been previously shown. However, various gases such as carbon monoxide, hydrogen, methane, isobutane and the like can be detected with a high degree of selectivity through the constitution of the second gas sensor though the relative sensitivity varies depending on the kinds and the combination of the electrodes.

As described above, with a gas sensor section used for detecting incomplete combustion, since it is possible to construct it by patterning and stacking the thin film on the substrate and to apply a processing technique like photolithography, which is a manufacturing process technique of semiconductor, to manufacturing of this sensor, the gas sensor has the constitution which allows manufacturing sensor elements with uniform performance (manufacturing variation in the characteristic of gas detection is less) at low cost and in large quantity. And, it is also possible to integrate and consolidate the various functions of sensor with very little increase in the manufacturing cost.

### BRIEF DESCRIPTION OF THE DRAWINGS

FIG. 1 is a sectional view of a gas sensor of example 1 according to the present invention.

FIG. 2 is a sectional view of a gas sensor of example 2 according to the present invention.

FIG. 3 is a sectional view of a gas sensor of example 3 according to the present invention.

FIG. 4 is a sectional view of a gas sensor of example 4 according to the present invention.

FIG. 5 is a sectional view of a gas sensor of example 5 according to the present invention.

FIG. 6 is-a sectional view of a gas sensor of example 6 according to the present invention.

FIG. 7 is a sectional view of a gas sensor of example 7 according to the present invention.

FIG. 8 are a graph showing diagrammatically a pulsed voltage applied to a heating element (FIG. 8A) and a graph showing a detection timing of the output (FIG. 8B) in a method of sensing the gas concentrations of example 8 according to the present invention.

FIG. 9 is a graph showing diagrammatically a differential output of a gas sensor on the gas concentrations in a method of sensing the gas concentrations of example 8 according to the present invention.

FIG. 10 is a block diagram of an apparatus for sensing the gas concentrations of example 9 according to the present invention.

FIG. 11 is a block diagram of an apparatus for sensing the gas concentrations of example 10 according to the present invention.

FIG. 12 is a graph showing detection characteristics based on pulsed driving of a prototype gas sensor 1 according to the present invention.

FIG. 13 is a graph showing the results in evaluating the stability of resistance when operating a gas sensor 1 according to the present invention by pulsed driving.

### DETAILED DESCRIPTION OF THE INVENTION

Description of the Preferred Embodiments

Hereinafter, a gas sensor of an embodiment according to the present invention will be described.

Embodiment 1

A gas sensor of embodiment 1 according to the present invention comprises a heating element stacked on the heat-resistant glass base substrate in the form of a plate, an insulating layer and a layer of solid electrolyte, and has further a pair of electrodes and a layer of porous oxidation catalyst formed so as to cover the one electrode surface on the layer of solid electrolyte.

The basic operations of the gas sensor of this embodiment 1 are as follows. That is, the solid electrolyte becomes active condition by energization to the heating element and heating, and in this condition, the concentration of carbon monoxide is sensed with the output of electroddmotive force between electrodes, which is based on the difference between chemical potentials, produced in the event of the generation of carbon monoxide, between the one reference electrode provided with a porous catalyst layer and the other detecting electrode not being provided with a porous catalyst layer.

In the gas sensor of embodiment 1 constructed as described above, even if a gas sensor element section is heated rapidly by applying a voltage intensively to the heating element only during a short time of the order of milliseconds with the intention of saving the operation power for a battery drive, the heat-resistant glass substrate is not broken in cyclic operations thereof over the long run since it is superior in thermal shock resistance.

And, in the gas sensor of this embodiment 1, micro-processing process used for manufacturing semiconductor is applicable and sensors having stable quality can be manufactured at low cost and in large quantity since a sensor element is formed by stacking a thin film on the heat-resistant glass base substrate in the form of a plate.

Embodiment 2

A gas sensor of embodiment 2 according to the present invention is constructed by forming a heating element, an insulating layer and a layer of solid electrolyte on the glass base substrate in the form of a plate and by forming a first electrode and a second electrode on the solid electrolyte film.

Next, the operation of the gas sensor of this embodiment 2 is described. In this gas sensor, by energization to the heating element and heating, the solid electrolyte becomes active condition and the electromotive force is produced between the first electrode and the second electrode, but this electromotive force varies depending on whether carbon monoxide is generated or not. That is, since the difference of electromotive force between the first and the second electrodes in the cases of the generation of carbon monoxide and without the generation of carbon monoxide takes the value uniquely corresponding to the difference between chemical potentials which are based on the oxygen concentration varying depending on the concentration of carbon monoxide, thereby, the gas to be detected like carbon monoxide can be detected. The detection of various gases such as methane, isobutane and the like also become capable by selecting the combination of the kinds electrodes depending on the gas to be detected. In this embodiment 2, by using the heat-resistant glass base substrate in the form of a plate, it is possible to decrease the heat transferred to the substrate and to raise the temperature of the solid electrolyte element section in a short time and efficiently as in the constitution of embodiment 1. It is possible to attain a higher degree of flexibility in selectivity on the gas to be detected compared with the constitution of embodiment 1 by constructing the first and the second electrodes using the combination of an inactive electrode and an active electrode or the combination of various active electrodes, depending on the kinds of the gas to be detected. And, it is also possible to detect two kinds of gases simultaneously through the use of the difference of temperature characteristics between the first and the second electrodes and the difference between temperature characteristics of gases in the same electrode system. Further, by dividing the solid electrolyte layer on one substrate and constructing respective elements, each of which detects different gas, in the divided solid electrolyte layers, respectively, it is possible to detect two or more kinds of gases simultaneously and therefore it has a wide range of applications such as the widespread use as a multiple gas sensor.

And, since the structure, in which thin films are stacked on the heat-resistant glass base substrate in the form of a plate, is employed, micro-processing process used for manufacturing semiconductor is applicable and sensors having stable quality can be manufactured at low cost and in large quantity.

Embodiment 3

A gas sensor of embodiment 3 according to the present invention has the same basic constitution as the previous embodiments land 2, and is constructed by using particularly a substrate selected from the group of quartz, crystalline glass and glazed ceramic as the heat-resistant glass base substrate in the form of a plate. Any of these base materials has desirable characteristics in the operation by pulsed driving of the invention, to which the thermal shock is applied repeatedly, because in addition to having basic heat resistance and insulating properties, it has a thermal shock resistance coefficient of 200° C. or higher and the low thermal conductivity, and is superior in thermal shock resistance even when heat is input in a short time and capable of transferring the heat effectively to the element side without transferring the heat to the substrate when possible. The operations as the gas sensor of this embodiment are similar to that of the previous embodiments 1 and 2.

Embodiment 4

A gas sensor of example 4 according to the present invention is constructed by adopting platinum base metal thin films as a heating element. Though platinum sometimes forms oxides to volatilize under a high temperature above 1,000° C., this metal is very stable in the heat resistance and in chemical properties under 500° C. which is the scope of the present invention. Though aluminum or its alloy, or copper is much used as conductors in semiconductor industries, platinum can reduce a failure rate such as breaks of the heating element, leading to the deterioration of the characteristic, due to electro migration or stress migration by two orders relative to these conductors in the case of the present invention where current with a large current density is applied to a thin film to be used. And, even when a pattern is constituted of a thin film to be used, platinum has a proper volume resistivity value. Furthermore, when platinum is used as a thin film heating element, using sputtering or an electro beam deposition, the thin film heating element can be formed into various required patterns such as a zigzag pattern with relative ease by metal masking, lift-off method or etching. And, platinum has a catalytic activity but since it is possible to eliminate its influence by enveloping platinum wholly with an insulating layer, there is no problem. In the present invention it is also possible to use a platinum base metal thin film such as ZGS platinum, being superior in high temperature creep strength, in which rhodium alloys or zirconia particles are added to pure platinum to enhance, for the sake of stabilizing the platinum characteristic. It is possible to enhance the reliability of the stable repeated energization operation of the heating element by using this heater to construct the gas sensors of embodiments 1 to 3. The operations in using the gas sensor of this constitution are similar to the previous embodiments.

Embodiment 5

A gas sensor of embodiment 5 according to the present invention is one in which a thin film, selected from Ti or Cr, with a film thickness of 25 Å to 500 Å is formed as a groundwork film of a heating element (a film formed between the heating element and the substrate for enhancing the cohesion between both of the element and the substrate mainly). Since the platinum base metal does not form stable oxides with oxygen, a platinum base metal thin film used to a heating element has less adhesion with the substrate based on a glass such as quartz superior in the thermal shock resistance. Accordingly, there is a risk of varying in the resistance of the heating element due to the internal thermal stress by repeated rapid heating operations of a short time in a pulse form as a heating element. Therefore, in this constitution, a joining layer is formed by adopting Ti or Cr, which joins with the platinum base metal well and also joins with quartz strongly through formation of oxides, between the substrate and the heating element. And, when the joining layer becomes excessive in an amount, there is possibility that it could interdiffuse with the platinum base metal and depress the adhesion. Further, this sometimes causes the formation of oxide and also in this case, there is possibility that the adhesion is depressed. Considering this point, as a film thickness of the joining layer, a range of from 25 Å to 500 Å is preferably used, and the enhancement and the stability of joining property are compatible within this range of film thickness and therefore good characteristics can be secured. Thereby, the substrate and the heating element can retain the strong and stable adhesion and the more stable operation by pulsed driving becomes possible.

Further, the operations of the gas sensor of this embodiment 5 are similar to the previous embodiments.

Embodiment 6

A gas sensor of embodiment 6 according to the present invention is constructed by forming further porous oxidation catalyst on either electrode of a first electrode or a second electrode in the constitution of embodiment 2, that is, a gas sensor in which a heating element, an insulating layer and a layer of solid electrolyte are formed on the heat-resistant glass base substrate in the form of a plate and a first electrode and a second electrode are formed on the solid electrolyte.

By the way, in the gas sensor of embodiment 6, when the first electrode and the second electrode are the same, this constitution is the same as that of embodiment 1. In the constitution of the gas sensor of embodiment 6, when different electrodes are combined to use as the first and the second electrodes, the selectivity as a gas sensor can be enhanced and the operating temperature can be reduced by constructing the gas sensor in such a way that oxygen reaches but the gas to be detected does not reach one electrode by combining electrodes which are both good in taking oxygen into the solid electrolyte and mutually different in the selectivity of catalytic oxidation. The operation principle of the gas sensor of this constitution is similar to that of embodiment 2 previously described except that the selectivity of gas is enhanced for the above-mentioned reason.

Embodiment 7

A gas sensor of embodiment 7 according to the present invention is constructed by forming a plurality of electromotive force type gas sensor element sections with an insulating layer interposed on the heat-resistant glass base substrate in the form of a plate on which a heating element is formed.

That is, in a gas sensor of this embodiment 7, a heating element is formed on the heat-resistant glass base substrate in the form of a plate, and an insulating layer is formed on the heating element, and a plurality of solid electrolyte elements for detecting different gases are further formed on the insulating layer. In a gas sensor of embodiment 7 constructed thus, by supplying power to the common heating element repeatedly through pulsed energization, a plurality of solid electrolyte elements become able to drive simultaneously for every pulsed energization and therefore two or more kinds of gases can be detected and quantified for every one pulse.

In the gas sensor of embodiment 7, by constructing each element separately into the solid electrolyte layer and the electrodes on a process, a multiple gas sensor, into which a plurality of gas sensors are integrated, can be fabricated with not-so-large cost differentials compared with the cost of manufacturing a single gas sensor. Since the solid electrolyte type element detects the gas by the electromotive force resulting from the difference of chemical potentials between electrodes, downsizing the sensor through downsizing the element does not adversely affect the operations in principle. Accordingly, it is possible to operate a plurality of gas sensors simultaneously with the same input energy as the case of forming a single solid electrolyte element to drive the sensor. Accordingly, it is possible to detect many kinds of gases simultaneously with one battery source for driving. And, it becomes possible to enhance the sensitivity by forming the multiple solid electrolyte gas sensor designed for detecting the same gas on one substrate to sum multiple output values output from the respective element, and it becomes possible to estimate the deterioration conditions of the porous oxidation catalyst or the electrodes by performing an operation and judging an output pattern. Thereby, it is also possible to incorporate a means for resolving the issue such as reduction of a risk to a wrong alarm into an alarm device.

Further, when two gas sensor are integrated into a constitution, it becomes possible to keep the sensitivity constant as follows if a gas sensor is constructed, for example, in such a way that a film thickness of a pair of electrodes on a first solid electrolyte coating and a film thickness of a pair of electrodes on a second solid electrolyte coating are different at least by 50%. With respect to the film thickness dependency of solid electrolyte element, the element with a thin film thickness is generally high in the sensitivity and output. Further, the element with a thick film thickness is low in the sensitivity and output, but excellent in durability. Taking advantage of this, it is possible to determine a degradation state of the electrode by observing ratios of a zero point and an output of the first solid electrolyte element to those of the second solid electrolyte element, respectively, when a gas sensor is constructed in such a way that the film thickness of a pair of electrodes on the first solid electrolyte coating and the film thickness of a pair of electrodes on the second solid electrolyte coating are different at least by 50%. When the zero point of the side with a thinner film, i.e., the side with higher sensitivity shifts to plus side and the output decreases, a correction to the degradation of the electrode can be performed by increasing an amplification factor of output value summed. As for an electrode the film thickness of which is increased by 50% or more relative to a film thickness which can ensure adequately both the sensitivity and the reliability, its output level decreases but the stability of characteristics is extremely enhanced. Therefore, when based on the information on the degradation of the electrode obtained from electrodes being different in the film thickness, the amplification factor of output signals of a sensor is increased, the sensitivity of the gas sensor can be apparently kept constant for a long time of period and the operation with a extremely high degree of reliability, with which an apparent sensitivity of the sensor does not change in case of the degradation of the electrode, becomes possible. A method of using electrodes different in film thickness like this can be realized by varying patterns and repeatedly applying sputtering (the number of sputtering of one electrode is increased compared with that of the other electrode by using masking which covers the surface of one electrode and opens the surface of other electrode). A method of forming films may be changed to sputtering or an electro beam deposition.

Embodiment 8

A gas sensor of embodiment 8 according to the present invention is constructed by providing an electromotive force type gas sensor section and a semiconductor gas sensor section with an insulating layer interposed on the heat-resistant glass base substrate in the form of a plate, on which a heating element is provided.

This embodiment is one which drives a solid electrolyte element and a semiconductor element simultaneously and detects two or more kinds of gases by using a heating element as a common heating source. In this embodiment 8, by pulsed energization to the heating element, the solid electrolyte element becomes active condition and also the semiconductor gas sensor element is operated. The operations of the solid electrolyte element are similar to the previous embodiments. The operations of the semiconductor element are described. Though a pectinate electrode is formed in the semiconductor type gas sensor and the material of the pectinate electrode can be composed of gold, platinum or the like, platinum is preferably used for the viewpoint of the ability to be shared among processes and heat resistance/thermal stability. And, it is desirable to form films by PVD process in order to form the electrode under the conditions of high precision patterning.

N-type semiconductor oxides, used in the semiconductor type gas sensor, such as zinc oxide, tin oxide and indium oxide used in the semiconductor type gas sensor becomes high in resistance in an oxidizing atmosphere of high temperature since under this conditions, the surface potential of oxygen is below the Fermi levels of these oxides, and therefore oxygen is adsorbed with negative charge, electrons of the n-type semiconductor oxides are trapped on oxygen and a space-charge layer with a low electron density is formed on the surface of the n-type semiconductor oxides. However, when the gas to be detected (reducing gas) is present, adsorbed oxygen is consumed on the surface of the n-type semiconductor oxides by the reducing gas and electrons trapped on oxygen are returned to the n-type semiconductor oxides, and therefore an electron depletion layer (space-charge layer with a low electron density) vanishes and the element becomes low in resistance. The semiconductor type gas sensor detects the reducing gas by making use of such a principle. It is possible to further increase the detecting sensitivity by using sensitizers like palladium, gold and silver in conjunction with n-type semiconductor oxides such as zinc oxide, tin oxide and indium oxide. Because semiconductor gas sensor elements, in which the sensitizers like palladium, gold and silver are used in conjunction with n-type semiconductor oxides such as zinc oxide, tin oxide and indium oxide has the maximum sensitivity to methane in a temperature range of 400° C. to 500° C. required for driving of the 0.5 solid electrolyte element, in the gas sensor of this embodiment 8, methane can be detected by the semiconductor gas sensor elements while carbon monoxide is detected in the solid electrolyte element through pulsed driving. And, in the gas sensor of this embodiment 8, when the pulsed driving of the order of milliseconds applied to the heating element is stopped, two gas sensor elements decrease in temperature at a speed corresponding to a heat content thereof and an ambient temperature. It is possible to detect isobutene having a maximum sensitivity at a temperature of 300° C. to 350° C. and also to detect carbon monoxide having a maximum sensitivity at a temperature of 100° C. to 150° C. by using the semiconductor type gas sensor among them. However, in detecting carbon monoxide using a semiconductor type gas sensor, there is a problem that since the temperature of a region where the sensor sensitivity is maximum is low, the risk of wrong alarms on the moisture or various miscellaneous gases in an atmosphere of high humidity essentially increases. Therefore, carbon monoxide sensors of semiconductor type have not been conventionally accepted. However, this sensor can be complemented as a multiple sensor by using in conjunction with a solid electrolyte element which is not sensitive to moisture at all like this embodiment 8.

Embodiment 9

A gas sensor of embodiment 9 according to the present invention is constructed by forming a resistance film and a plurality of electromotive force type gas sensor sections with an insulating layer interposed on the insulating substrate in the form of a plate, on the surface (top face) of which a heating element is formed.

In a constitution of this embodiment 9, the operations of the respective electromotive force type gas sensors are similar to the previous embodiments.

In this embodiment 9, the resistance film is used in order to sense the air temperature to be utilized for notifying the fire. As the resistance film, a platinum base metal thin film identical to the heating element used as a heating means can be used by patterning. A thin film of Ti or Cr may be used as a buffer film between the substrate and a resistance film for enhancing the adhesion with the substrate. In sensing temperature, temperature can be known through measuring the resistance making use of the intrinsic resistance temperature coefficient of the resistance film. The constitution of this embodiment 9 allows collecting data at an adequate timing when there is little effect of heat on the electromotive force type gas sensor. For example, when the substrate with high thermal impact resistance such as quartz is used, thermal effect on the electromotive force type gas sensor becomes extremely small at about 1 second after energization is off in the case of pulsed driving of the order of 10 milliseconds since this has a low thermal conductivity. It is possible to perform an alarm of notifying the fire with a high degree of accuracy by combining this gas sensor with the electromotive force type gas sensor for detecting carbon monoxide. The reason for this is as follows.

That is, carbon monoxide is produced in a large amount due to the initial combustion of paper, fibers, woods, lumber or the like in the fire. It is known that there are many cases where occurrences of unfortunate fatality in the fire result from this carbon monoxide poisoning accidents. If it is possible to detect simultaneously carbon monoxide and the temperature increase due to the fire with the electromotive force type gas sensor and to notify the fire by the constitution of this embodiment 9, the reliability of the fire alarm is enhanced. Since this constitution includes, particularly, such a-heat-sensitive sensor section for notifying the fire and a gas sensor section for detecting carbon monoxide on one substrate, it is possible to notify the fire with a high degree of reliability.

Embodiment 10

A gas sensor of embodiment 10 according to the present invention is constructed by forming a resistance film, an electromotive force type gas sensor section and a semiconductor type gas sensor section with an insulating layer interposed on the insulating substrate in the form of a plate, on which a heating element is formed. That is, this embodiment 10 has the constitution of combining the previous embodiments 8 and 9.

It is possible to detect two or more kinds of gases, for example, carbon monoxide and methane, or carbon monoxide and isobutane or to perform the double-detection of the carbon monoxide based on different principles as described above. Further, in addition to these, the detection of heat-sensitive type for notifying the fire becomes possible simultaneously. Since a gas sensor of embodiment 10 is integrated on the substrate with a heat source common, the manufacturing cost of a gas sensor and the power consumption of a battery in the case of operating by pulsed driving as a multiple gas sensor are not so different from those of a single-function sensor.

Embodiment 11

A method of sensing the gas concentrations of the gas sensor of embodiment 11 according to the present invention is a method in which in the gas sensor comprising an electromotive force type gas sensor section with an insulating layer interposed on an insulating substrate in the form of a plate on which a heating element is formed, the heating element is periodically operated by pulsed driving and the gas concentrations are sensed based on the average of the electromotive force values exhibited by the electromotive force type gas sensor section within an arbitrary minute time of period on either side antecedent to or after the time of interruption of the operations of the heating element. This method is intended to save the power for enabling the battery driving in the solid electrolyte gas sensor of an electromotive force type. The basic principle for saving power is a concept that by inputs to the heating element during an adequately short time, for example, several milliseconds, which is required for driving of a solid electrolyte element, the element is provided with the energy required for the operation of a solid electrolyte element of an electromotive force type and energy loss due to the release of heat through air or the substrate is reduced.

In this concept, an issue is whether information concerning the concentration of gas to be detected can be actually attained from the solid electrolyte element of an electromotive force type by means of the short energy input of the order of several milliseconds, but the inventor et al. verified that by collecting the average of the electromotive force values exhibited by the electromotive force type gas sensor in the form of a time series within an arbitrary minute time of period on either side antecedent to or after the time of interruption on the repeated energy input in pulse form to the heating element, the change in gas concentrations in the ambient where the sensor is placed could be adequately detected, based on the data collected being discontinuous and discrete. Though an impedance between both electrodes on the solid electrolyte is high because of low temperature and signals are buried in noise immediately after energization to the heating element, temperature of each element section of the solid electrolyte element is raised with energization and it becomes possible to recognize an output voltage with increase in temperature. For example, it is possible to obtain significant output signals, which relates to the gas concentration, by receiving signals between both electrodes and taking in the signals of adequate timing, using a differential operational amplifier with high impedance. When a temperature boot operation by means of a short energization in a pulse form is repeated at definite time intervals, the solid electrolyte element increases and decreases in temperature repeatedly, based on the characteristic based on its thermal time constant, and it is possible to put the solid electrolyte element under the temperature condition above a definite temperature at which the solid electrolyte element is sufficiently active in some time of period antecedent to or after the time of interruption of the energyzation of a short time in pulse form, and therefore if such a timing is selected to collect the output of the electromotive force between both electrodes in an arbitrary minute time of period, a discrete output value can be obtained. This discrete output value of the electromotive force retains a constant value in the case where the concentration of the gas to be detected is zero but it increases corresponding to the increase in the concentration of the gas to be detected in the case of increase in the concentration of the gas to be detected. Thereby, the operation of the electromotive force type gas sensor of the solid electrolyte, i.e., the battery driving of extremely low power consumption becomes possible.

Embodiment 12

A method of sensing the gas concentrations of the gas sensor of embodiment 12 according to the present invention is a method in which in the gas sensor comprising an electromotive force type gas sensor section with an insulating layer interposed on an insulating substrate in the form of a plate, provided with a heating element, the heating element is periodically operated repeatedly and the gas concentrations are sensed based on the average of the electromotive force values exhibited by the electromotive force type gas sensor section within an arbitrary minute time of period on either side antecedent to or after the time of intermittent interruption of the heating element, and particularly a method of using a gas sensor constructed by providing with a solid electrolyte layer and a first and a second electrodes on the solid electrolyte of the solid electrolyte layer as an electromotive force type gas sensor. This embodiment 12 is a method of applying the gas sensor of embodiment 2 in a method of sensing the gas concentrations according to embodiment 11. The method of sensing the gas concentrations is essentially similar to the method of the embodiment 11. And, the operations of the gas sensor are similar to the descriptions of the embodiment 2.

Embodiment 13

A method of sensing the gas concentrations of embodiment 13 according to the present invention is a method in which in the gas sensor comprising an electromotive force type gas sensor section with an insulating layer interposed on an insulating substrate in the form of a plate, provided with a heating element, the heating element is periodically operated repeatedly and the gas concentrations are sensed based on the average of the electromotive force values exhibited by the electromotive force type gas sensor section within an arbitrary minute time of period on either side antecedent to or after the time of intermittent interruption of the heating element, and particularly a method of using a gas sensor constructed by providing with a solid electrolyte layer, a pair of electrodes on the solid electrolyte of the solid electrolyte layer and a porous oxidation catalyst layer on the one electrode as an electromotive force type gas sensor.

This embodiment 13 is a method of applying the gas sensor of embodiment 1 based on a method of sensing the gas concentrations according to embodiment 11. The method of sensing the gas concentrations is essentially similar to the method of the embodiment 11. And, the operations of the gas sensor are similar to the descriptions of the embodiment 1.

Embodiment 14

An apparatus for sensing the gas concentrations of embodiment 14 according to the present invention is constructed by comprising a gas sensor including an electromotive force type gas sensor element formed with an insulating layer interposed on the heat-resistant glass base substrate in the form of a plate, including a heating element, a power supply means which supplies electric power to the heating element of the gas sensor element, a power control means of controlling the power applied to the heating element, a detection means of the electromotive force signals for detecting the electromotive force output from the gas sensor and a signal control means.

Heating of the heating element is carried out by the power supply means. The power supply means is a power supply circuit including a direct-current-to-direct-current converter of boosting the voltage of a power supply like a battery to the voltage required for using to heat the heating element. In this power supply circuit, power is input based on a resistance-temperature characteristic which the heating element has, and for example in the case of platinum base thin film, since the heating element has a positive resistance temperature coefficient, it is possible to raise a temperature, e.g., to about 450° C. by inputting power in such a way that resistance in an operation is about 22 Ω when pattern is designed to be 10 Ω at 20° C. In this embodiment 14, since the gas sensor is the electromotive force type element and constituted of a thin film, an average temperature of the electromotive force type element can be estimated as a temperature of the heating element by measuring voltage of the current supply means and current passing through the heating element. And, a sequential control of periodic intermittent heating and a voltage control or a current control for preventing the heating element temperature from running away are required for the operation by pulsed driving. Since a constant current control has a large initial inrush current and has a possibility of a sudden rise in temperature of the heating element from the resistance temperature characteristic of the heating element, measures in which the constant current control is used initially and it is switched to the constant voltage control on its way are effective. The power control means takes charge of this control. Further, the power control means is constructed so as to perform the sequential control in conjunction with the signal control means including a microcomputer.

The electromotive force type gas sensor reaches a temperature required for operation thereof by such an operation by pulsed driving and outputs an electromotive force corresponding to the environment of gas concentrations in the ambient. In the apparatus of this embodiment 14, it is possible to collect data in required time at an adequate timing calculated by a signal control means provided with the microcomputer. Since the output from the electromotive force type gas sensor is a signal of a level of millivolt with high impedance, it is amplified to an easy-to-control signal by a signal amplification means composed of an operational amplifier or a differential operational amplifier incorporated into a detection means of the electromotive force signals. Signals amplified by the signal amplification means are taken into the signal control means as time series data to be stored. These data will be used as required. The method of using the data can be used in alarming buzzers, emitting light signals such as liquid crystal and LED, or in controlling the operations of closing the valves for a gas supply when the gas concentrations of an alarm exceed the set point through the medium of a communications means.

Embodiment 15

An apparatus for sensing the gas concentrations of embodiment 15 according to the present invention is constructed by comprising a gas sensor including an electromotive force type gas sensor section formed with an insulating layer interposed on the heat-resistant glass base substrate in the form of a plate, including a heating element, a power supply means which supplies electric power to the heating element, a power control means of controlling the power applied to the heating element, a detection means of the electromotive force signals for detecting the electromotive force output from the gas sensor, a signal control means and an alarm-notifying means alarming in recognizing with a comparison means that the concentration of the gas to be detected is equal to or higher than the predetermined reference concentration.

The basic operations of the apparatus for sensing the gas concentrations of this constitution are similar to the previous embodiment 14. In this constitution, there are provided an alarm-notifying means generating an alarm and a function capable of performing an alarm operation of alarming or emitting light signals when the concentration of the gas to be detected is compared with a comparison value corresponding to the predetermined concentration on the electromotive force output signal of time series stored in the signal control means by the comparison means and an incremental signal of the electromotive force output signal per unit time exceeds the comparison value.

### EXAMPLE

Hereafter, examples of the invention will be described referring to drawings.

### Example 1

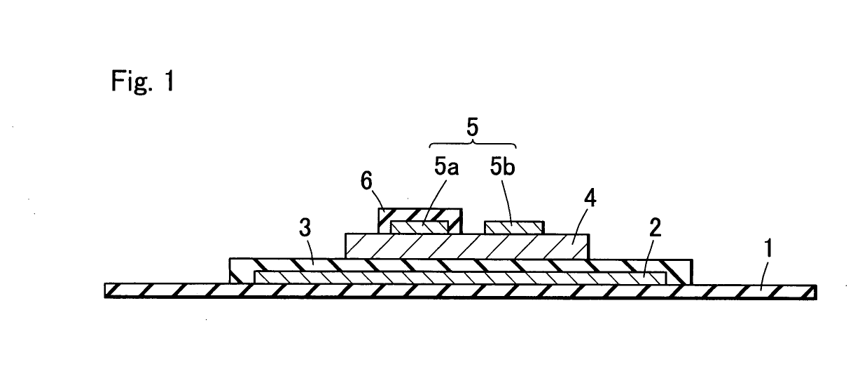

FIG. 1 is a sectional view illustrating conceptually a gas sensor of example 1 of the invention. In FIG. 1, reference numeral 1 denotes the heat-resistant glass base substrate in the form of a plate. As shown in FIG. 1, the heating element 2 and the insulating layer 3 are formed in the form of overlaying one another on the substrate 1, and the solid electrolyte film 4 is further formed on the insulating layer 3. And, a pair of electrodes 5 are formed on the surface of the solid electrolyte film 4 and a layer of porous oxidation catalyst 6 is formed on one electrode 5a so as to cover the one electrode 5a.

The reason for using the heat-resistant glass base substrate 1 in this example is that this substrate material has a characteristic suitable for an operation by pulsed driving. That is, it is preferred for the substrate used for the gas sensor operated by pulsed driving to have a large thermal shock resistance coefficient primarily, to be low in the thermal conductivity secondly and to be small in the difference of thermal expansion coefficients between the substrate and the solid electrolyte or the like thirdly. It is considered to be important among these that thermal expansion coefficient of the substrate is as large as that of the solid electrolyte element and that its thermal conductivity is low. Even if the thermal expansion coefficient is a little different from the solid electrolyte layer 4, this difference can be accommodated when the difference is low since a film thickness of the solid electrolyte film 4 is thin. Material of the heat-resistant glass base substrate satisfies this condition. A thermal shock resistance coefficient is represented by differentials of critical temperatures between antecedent to and after heating, at which the substrate is not broken due to thermal stress in heating instantly, and material having a large thermal shock resistance coefficient is less prone to breakages. For example, the thermal shock resistance coefficient of alumina is on the order of 50° C.

The reason for selecting the heat-resistant glass base substrate having a large thermal shock resistance coefficient as a substrate in the present invention is based on the results of preliminary comparisons and evaluations on various base materials as follows. That is, the reason for selection is based on the experimental facts that in the gas sensor using mullite, alumina, or zirconia (3Y) having the thermal shock resistance coefficient of 200° C. or lower as substrate, any substrate was broken by pulsed heating, and on the contrary any substrate was not broken when the heat-resistant glass base substrates such as quartz glass having the thermal shock resistance coefficient of 3000° C., various cermets and crystalline glass were used, and based on that the heat-resistant glass base substrate has the extremely low thermal conductivity of 1.3 W/m·K or less. That the thermal shock resistance coefficient is equal to or higher than 200° C. becomes one condition for the substrate which does not produce cracks while the substrates is raised to a temperature of 250° C. to 500° C. required for driving of the solid electrolyte element in a short time of the order of milliseconds. And, as conditions other than physical properties, which are required for heat-resistant glass base material, a control of surface roughness of the base material is important. This surface roughness concerns a buffer effect which accommodates stress resulting from the morphology of an interface between the solid electrolyte film and the electrode, which concerns performances of the electromotive force type gas sensor, and the differences of thermal expansion coefficients between the substrate and the solid electrolyte film. Therefore, the surface roughness of the substrate is set optimally, considering these two influences. Specifically, The surface roughness is preferably set in a range of center line surface roughness Ra of 0.05 to 1 μm. It is preferred to apply special polishing in order to allow the surface roughness to fall within this range.

Since materials such as quartz glass, crystalline glass and glazed ceramic, which are substrate materials, satisfying the above-mentioned conditions, suitable for the present invention, are low in the thermal conductivity in addition to the high thermal shock resistance, these materials are less in thermal conduction to a lower side of the substrate, and can prevent the heat from escaping from the substrate side and transfer effectively the heat to the element side. When the substrate having such a characteristic is used for a gas sensor, a region heated by heating for about 10 milliseconds will be a narrow region with a distance of about 30 mm from the heating element, and therefore only a restricted region of the substrate can be efficiently heated and an efficient pulsed heating operation becomes possible.

Particularly, quartz glass has a desirable characteristic as a substrate material of the gas sensor of the present invention. When this quartz glass is used as a substrate, alkali content concerns not only the heat resistance and the thermal shock resistance but also characteristics of the insulating coating and the element stacked and formed on the substrate. The alkali content is represented by hydroxyl content and as quartz glass used to the present invention, preferably, hydroxyl content does not exceed 0.2%, and more preferably, quartz glass containing hydroxyl of 1,000 ppm or less is used.

A heating element 2 is formed into a pattern like a zigzag pattern on the substrate in such a way the heating element has predetermined resistance by forming films of platinum or its alloys to use. It is desired to form a Cr or Ti thin film between the substrate 1 and the metal composing a heating element in order to enhance the adhesion with platinum base metal of a heating element. Since the platinum base metal of a heating element does not form stable oxides and so it is difficult to strongly join with the substrate such as quartz glass, it is desirable for the use of the heating element to form Cr or Ti thin film, which joins with the platinum base metal well and also adheres with the substrate strongly through forming stable oxides, between the substrate and the metal. Desirably, film thicknesses of these groundwork films (Cr or Ti layers) range from 25 Å to 500 Å. When the film thickness is below 25 Å, there are problems on forming a film that film thickness becomes nonuniform and when the film thickness is over 500 Å, improvement of the adhesion is impaired due to the growth of oxides or the film interdiffusion or reaction with platinum base metal.

As a method of forming the respective functional coatings applied to the present invention, any of wet processes by spinner or screen printing or dry processes such as an electro beam deposition or sputtering is applicable. And, with respect to patterning to predetermined patterns which is common for each functional coating, any of a method of forming coatings by using metal masking, lift-off method using a patterned metal such as aluminum or copper, and etching processing by photolithography, e.g., reactive ion etching is applicable.

As an insulating film 3, a thin film such as silica, alumina, silicon nitride, and polysilicon can be used. In this time, two or more films may be used in adequate combination, considering thermal expansion. As a film thickness of the insulating film 3, a range of 0.5 μm to several μm is preferably used. When the film thickness becomes larger, the risk of cracks of the insulating film due to the difference of thermal expansion increases.

For the solid electrolyte film 4, any of oxygen ionic conductors such as yttrium stabilized zirconium or scandium stabilized zirconium, complex oxide oxygen ionic conductors such as bismuth oxide-molybdenum oxide and cerium oxide-samarium oxide, fluoride ionic conductors and various hydrogen ionic conductors is applicable. Some kinds of conductors can operate at a low temperature but oxygen ionic conductors are desirably used from the viewpoint of stability to moisture.

For a pair of electrodes 5 formed on the surface of the solid electrolyte film 4, silver, platinum, palladium, ruthenium and metal oxide, especially perovskite type complex oxide and pyrochlore type complex oxide are applicable in terms of the adsorption of oxygen ion and the mobility of oxygen ion toward the solid electrolyte. And, considering the heat resistance in addition to the characteristic of taking oxygen into the solid electrolyte, platinum, perovskite type complex oxide and the like are desirable.

Desirably, perovskite type oxide used as the electrode 5 is one using metal based on lanthanum at A site and a kind of metal selected from the group consisting of iron, manganese, copper, nickel, chromium and cobalt at B site, one in which A site and B site are partly replaced with rare-earth elements or transition elements or one in which B site is partly replaced with noble metals such as gold, palladium and rhodium. These perovskite type oxides have extremely many defects of lattice oxygen and become active, and reduction of an acceleration operation temperature and an improvement of response are expected by means of taking oxygen into the solid electrolyte interface.

The porous oxidation catalyst layer 6 is formed for the sake of allowing the electrode 5a on the side where the porous oxidation catalyst layer is formed to function as a reference electrode. That is, the catalyst layer 6 is used to retain the concentration of oxygen in the vicinity of the reference electrode 5a constant and to allow the concentration of oxygen adsorbed on the reference electrode 5a not to change regardless of the production of reducing gas. Further, in this specification, the reference electrode 5a is also referred to as an electrode of high-oxygen concentration since the concentration of oxygen adsorbed on the reference electrode 5a is higher than that of other electrode 5b in the atmosphere including the reducing gas. Specifically, the porous oxidation catalyst layer 6 has the capability of oxidizing the reducing gas like carbon monoxide perfectly and has a function in which oxygen reaches the electrode adequately but the reducing gas does not reach the electrode

The porous oxidation catalyst layer 6 consists of components such as a catalyst to be a base, a support for making the catalyst porous as required, a binder for forming films and the like.

Therefore, characteristics which are important for the porous oxidation catalyst layer 6, in which varying the kinds of a catalyst, a binder, means of forming a great many pores, means of forming films and methods of forming films allows the characteristics of the porous oxidation catalyst layer 6 to be different, are the oxidation activity to the gases to be detected, which has a reducing property, and the diffusion characteristic of oxygen. As a catalyst in which these characteristic can be set in desirable ranges, respectively, corresponding to the gas to be detected by varying the kinds of a catalyst, film thickness, a degree of to be porous and the like, oxides of noble metals such as platinum, palladium and rhodium and transition metals such as iron, manganese, copper, nickel and cobalt or complex oxides are used. Porous ceramic such as alumina is used for a support and inorganic adhesive such as glass, metal phosphates and the like are used for a binder, and these are made in paste under adequate dispersant and applied and sintered to form a catalyst.

For the gas sensor element section formed on the substrate, a terminal section of joining leads of the heating element and leads for supplying power to the heating element 2 are required, though these are omitted in FIG. 1. And, a terminal section of joining leads and leads to pull out the signal output of a pair of electrodes 5 are also required. Since in this example 1, platinum base metal is used to the heating element, platinum base metal is preferably used to leads and a terminal section of joining leads. For joining leads to a terminal, any of methods such as welding, brazing and calcination using platinum paste, which is conventionally publicly known, may be used.

The operations of the gas sensor element section fabricated in this way are described.

The solid electrolyte element (gas sensor element section) is instantly heated to a temperature of 250° C. to 500° C. required for its operation by pulsed energization to a heating element 2. Since an insulating film 3 is formed on the surface of the heating element 2, there is not a possibility that electrons flow into or react with the solid electrolyte 4, and the field effect of the heating element 2 appears in the sensor output. The solid electrolyte 4, a pair of electrodes 5 formed on the surface of the solid electrolyte and the porous oxidation catalyst 6 become working conditions by the energization to a heating element 2 and heating. In this situation, the electromotive force is not generated between electrodes when the sensor is placed in an atmosphere of air not containing the gas to be detected like carbon monoxide because the oxygen levels of the reference electrode 5a provided with a porous oxidation catalyst layer and the detecting electrode 5b not being provided with a porous oxidation catalyst layer are almost equivalent. On the other hand, in an atmosphere of air containing the gas to be detected like carbon monoxide, the electromotive force corresponding to the difference between the concentrations of carbon monoxide is generated between both electrodes and the potential between both electrodes is output. The concentration of the gas to be detected like carbon monoxide can be determined from the output of the potential and this enables the operations of alarming when the concentrations of carbon monoxide and the like exceed the predetermined level.

### Example 2

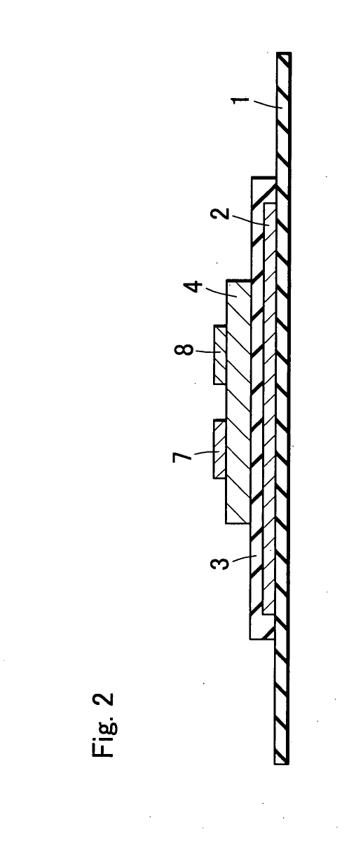

FIG. 2 is a sectional view illustrating conceptually the cross section of a gas sensor of example 2 of the invention. In FIG. 2, reference numeral 1 denotes the heat-resistant glass base substrate in the form of a plate. The insulating layer 3 is formed so as to cover the heating element 2 on the substrate 1, and the solid electrolyte film 4 is further formed on the insulating layer 3. Though up to this point, this example is similar to example 1, this differs from example 1 in the following points. That is, in this example 2, there are formed on the solid electrolyte film 4 a first electrode 7 and a second electrode 8 which are mutually different in the catalytic oxidation capacity on carbon monoxide as shown in FIG. 2.

In a gas sensor of example 2 constructed as described above, the solid electrolyte element, like example 1, is heated instantly to a temperature of 250° C. to 500° C. required for its operation by pulsed energization of a short time to the heating element 2. Since an insulating film is formed on the surface of the heating element, there is not a possibility that electrons flow into or react with the solid electrolyte and the field effect of the heating element appears in the sensor output. The solid electrolyte film 4 and the first electrode 7 and the second electrode 8 formed on the surface of the solid electrolyte film become working conditions by the pulsed energization to such a heating element 2 and heating. The first electrode 7 and the second electrode 8 are mutually different in the adsorption capacities of oxygen and carbon monoxide and the catalytic oxidation capacity of carbon monoxide.

In a gas sensor of example 2, in this working conditions, even when the sensor is placed in an atmosphere of air not containing the gas to be detected like carbon monoxide, the electromotive force outputs corresponding to the difference between the oxygen-adsorption capacities of two electrodes and the difference between the diffusion abilities into the respective three-phase interfaces which are sections for taking in oxygen of the solid electrolyte 4 are exhibited because the concentrations of oxygen adsorbed to the electrodes are different. When the sensor is used as an alarm, this point (output value of the electromotive force) is set as zero point (reference point).

On the other hand, in an atmosphere of air containing the gas to be detected like carbon monoxide, depending on the adsorption characteristic and the catalytic oxidation capacity of gas of the first electrode 7 and the second electrode 8, the electromotive force output changes by the difference between the outputs based on the oxygen concentrations at the respective electrodes, which relates to the concentration of carbon monoxide, from the output of the balanced electromotive force in air not containing carbon monoxide. Though the magnitude of this change becomes positive or negative depending on how to combine the electrodes, the absolute value of the difference between the outputs from the point defined as zero point is the value relating to the concentration of carbon monoxide. Accordingly, the concentration of the gas to be detected like carbon monoxide is determined from this absolute value of the difference between the outputs and an alarm operation becomes possible when carbon monoxide exceeds the predetermined concentration. Methane, isobutane and hydrogen can be detected other than carbon monoxide though the relative sensitivity varies depending on the kinds and the combination of the electrodes.

### Example 3

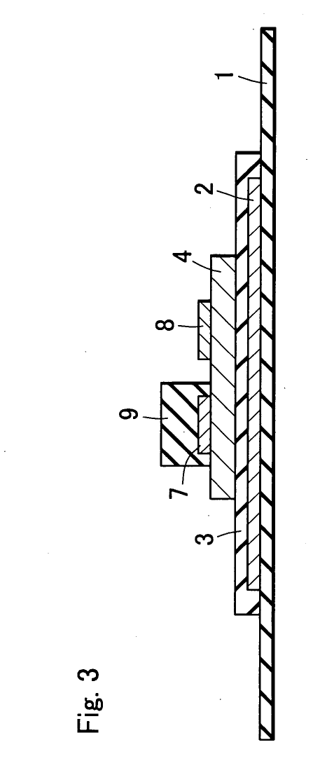

FIG. 3 is a sectional view illustrating conceptually the cross section of a gas sensor of example 3 of the invention. In FIG. 3, the similar parts to example 2 are shown with the like letters or numerals. This example 3 is different from example 2 in that a porous oxidation catalyst layer 9 is further provided on the first electrode 7. That is, this example 3 has the constitution of combining the previous examples 1 and 2. The function of the porous oxidation catalyst layer 9 is to operate the first electrode 7 as a reference electrode regardless of the presence of reducing gas as in the case of the porous oxidation catalyst layer of example 1. In this example 3, the combination of the first electrode 7 and the second electrode 8 allows methane to be detected and further the formation of the porous oxidation catalyst layer 9 on the first electrode 7 makes the first electrode 7 the reference electrode, which does not vary in the potential due to the presence and absence of reducing gas. In the gas sensor of example 3 constructed as described above, it becomes possible to prepare the element the carbon monoxide sensitivity of which is enhanced and in addition to construct the following multiple gas sensor.

There is described the case of forming a multiple sensor of, for example, carbon monoxide and methane. In the constitution of example 3, when as electrodes, complex elements, which are perovskite type complex oxides of ABO 3 type and A site of which is replaced with lanthanum (La) or partly replaced with rare-earth elements or alkaline-earth metals, are used, and as one electrode, perovskite complex oxide of manganese (Mn) and as other, perovskite complex oxide of cobalt are respectively used, the gas sensor having this constitution has the good sensitivity of methane selectivity at 400° C. but does not have the sensitivity to carbon monoxide at this temperature. However, it is possible to allow the gas sensor to function as a gas sensor not having the sensitivity to methane and having the high sensitivity to carbon monoxide at 250° C. by forming the porous oxidation catalyst layer on one (cobalt) electrode like this example. That is, in this example, when the gas sensor is constructed in such a way that carbon monoxide is detected at about 250° C. and methane is detected at about 400° C. in a process of temperature rise or temperature descent by pulsed energization, this sensor can be used as a multiple sensor of carbon monoxide and methane.

This gas sensor is essentially identical to example 1. Since the kind of the electrode of this sensor is different from another electrodes which have the same zero point and the same sensor sensitivity, this sensor sometimes has a little different characteristics from another sensors, but in this sensor, a substantially identical characteristic can be obtained. In terms of industrial applications, this sensor has an advantage of being able to attain a gas sensor which has the ability to detect different gases being different in the gas selectivity by forming newly porous oxidation catalyst layer on the surface of one electrode of different electrodes, taking a gas sensor having different kinds of electrodes as a origin.

### Example 4

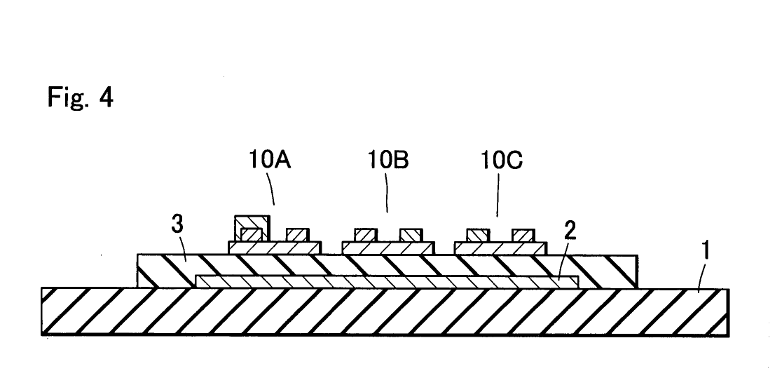

FIG. 4 is a sectional view illustrating conceptually the cross section of a gas sensor of example 4 of the invention. As shown in FIG. 4, a gas sensor of this example 4 is constructed by forming a plurality of electromotive force type gas sensor sections (10A, 10B, 10C) with an insulating layer 3 interposed on the heat-resistant glass base substrate 1 in the form of a plate, on which a heating element 2 is formed.

Though an example of forming three elements is shown in FIG. 4, any number of sensors may be formed if two or more sensors. This sensor can be formed by patterning each layer from lower side to upper side in turn with a thin film process and an electromotive force type gas sensor is constituted of multiple solid electrolyte elements. The efforts concerning processes to fabricate the solid electrolyte element are little different between the case of multiple solid electrolyte elements and the case of single solid electrolyte element. The respective solid electrolyte element may be a constitution in which a pair of electrodes are provided on each solid electrolyte separated into each element and a porous oxidation catalyst layer is formed on one electrode of the pair of electrodes (constitution of example 1), or may be a constitution which is constructed with the first electrode and the second electrode of different kinds (constitution of example 2), or further may be a constitution in which a porous oxidation catalyst layer is formed on one electrode of the two electrodes of different kinds (constitution of example 3).

The heating element 2 is formed on an insulating base material 1 by patterning a resistance material into patterns such as a zigzag.

As a method of patterning, it is possible to apply various methods such as a method of forming thin films patterned by using metal masking, dry or wet etching processes usually used in semiconductor lithography processing process and lift-off method. The heating element can be formed by using, for example, material based on platinum base noble metal, and it is possible to construct the good heating element, which is rapid in temperature boot required for applications to gas sensors and superior in reliability, by devising and forming patterns through processes of forming thin films such as an electro beam deposition and sputtering. An insulating film 3 is formed on the main portion of the heating element through a thin-film process as in the case of the heating element. The thin film of the solid electrolyte is formed on the insulating film 3 by patterning. As the solid electrolyte, any of oxygen ionic conductors such as stabilized zirconium, fluoride ionic conductors and proton conductors are applicable. As for a pair of electrodes formed on the solid electrolyte by patterning or electrode materials to be used as a first or a second electrodes, various kinds of materials such as silver, platinum, palladium, ruthenium and perovskite type oxide are applicable in terms of the adsorption of oxygen ion and the mobility of oxygen ion toward the solid electrolyte, but platinum base metal and perovskite type complex oxide are desirably used, considering comprehensively including the viewpoint of the heat resistance and the ability of forming the film. In any case using different materials, patterning process described in the paragraph of heating element can be used, and for example sputtering is given as a method of forming films. Further, the porous oxidation catalyst layer to be formed as required may be one which has a characteristic of allowing gas to permeate and further has a characteristic of oxidizing the gas to be detected when the gas to be detected like carbon monoxide permeates through thereof and as this catalyst one supporting oxidation catalyst on a various heat-resistant porous material can be used. This is also formed into a predetermined pattern with a thin film process or a thick film printing process.

A plurality of gas sensor elements 10A, 10B, 10C of the solid electrolyte type, which are fabricated in this way, are raised to a temperature of 250° C. to 500° C. required for operation thereof by energization to the heating element 2 and heating. Any of the respective elements 10A, 10B and 10C becomes an operable temperature by energization of the level of milliseconds since the constitution of the gas sensor is highly miniaturized by micro-processing. The operation of the element 10A is described. With respect to electrodes formed on the solid electrolyte, air containing the gas to be detected like carbon monoxide reaches one electrode and air from which the gas to be detected like carbon monoxide is removed by the porous oxidation catalyst layer reaches the other electrode, and therefore the output of the electromotive force of an oxygen concentration cell type corresponding to the concentration of the gas to be detected like carbon monoxide can be obtained between both electrodes. Thereby, the concentration of the gas to be detected like carbon monoxide can be sensed.

The same operations as the solid electrolyte 10A are also performed in the solid electrolyte 10B and 10C, which are different. The gas sensor of example 4 constructed as described above can obtain simultaneously outputs from multiple sensors by the operation of the common heating element. Therefore, in the gas sensor of this example 4, it becomes possible to enhance the apparent sensor sensitivity by summing multiple sensor outputs as it is. And, in multiple solid electrolyte elements, it becomes possible to change the sensitivity of each solid electrolyte element to the kinds of gases by changing the electrodes, the kinds of catalysts and conditions, and thus, it becomes possible to detect two or more kinds of gases simultaneously. And, when the element with a high sensitivity and the element with a low sensitivity are combined, it becomes possible to grasp information on the degradation of the sensor and to correct the sensitivity by performing an operation of a ratio between outputs of both gas sensors since the element with a low sensitivity has generally high durability. Thus, the reliability of the sensor can be enhanced. It is possible to overcome the issues of conventional gas sensors such as issues or problems of energy saving as a basic issue of the gas sensor, wrong alarm and further fail safe, which have been issues, by adopting the constitution of this example 4.

### Example 5

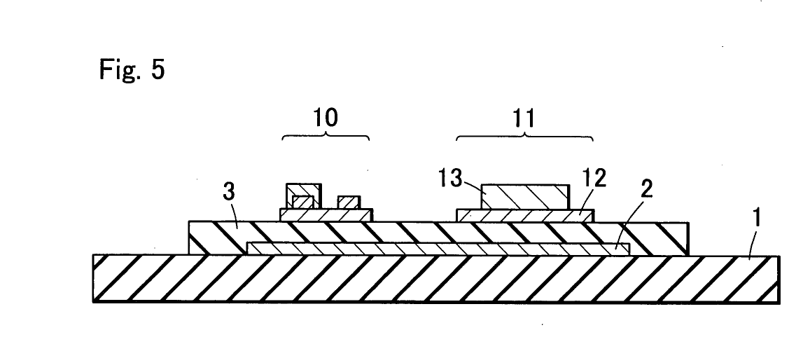

FIG. 5 is a sectional view illustrating conceptually the cross section of a gas sensor of example 5 of the invention. As shown in FIG. 5, a gas sensor of this example 5 is constructed by forming an electromotive force type element section 10 and a semiconductor type gas sensor section 11 with an insulating film 3 interposed on the heat-resistant glass base substrate 1 in the form of a plate, on which a heating element 2 is provided.

The specific constitution of the electromotive force type gas sensor section 10 being a solid electrolyte element with the insulating film 3 interposed may be any one of examples 1 to 3. On the other hand, the semiconductor type gas sensor section 11 is constructed by forming a pectinate electrode 12 on the insulating film 3 and forming an oxide semiconductor sensing film 13 on the pectinate electrode 12. The operation of the electromotive force type gas sensor section 10 in a gas sensor of example 5 constructed as described above is similar to that of the previous examples. That is, in an working condition where the electromotive force type element section is heated to a temperature of 250° C. to 500° C. by pulsed energization to the heating element, an oxygen concentration cell is formed and the output of the electromotive force corresponding to the concentration of the gas to be detected can be obtained between a pair of electrodes, or between the first and the second electrodes when the gas to be detected is present. On the other hand, with respect to the oxide semiconductor sensing film 13 formed on the pectinate electrode 12, electrons of the oxide semiconductor are trapped on oxygen adsorbed-with negative charge by pulsed energization of the heating element and a space-charge layer with a low electron density is formed on the surface of the oxide semiconductor, and the element becomes high in resistance. When the gas to be detected (reducing gas) is present there, adsorbed oxygen is consumed by combustion reaction with the gas to be detected and electrons trapped on oxygen are returned to the oxide semiconductor, and therefore an electron depletion layer vanishes and the element becomes low in resistance. Thus, the resistance of the oxide semiconductor sensing film varies depending on the concentration of the gas to be detected. Accordingly, it is possible to sense the concentration of the gas to be detected by detecting the change in resistance of the pectinate electrode. In this example 5, a temperature at which the sensing film has a maximum sensitivity varies depending on kinds of gases to be detected due to the composition of materials of the oxide semiconductor sensing film. For example, it is generally known that in methane, a maximum sensitivity is attained at a temperature of 400° C. to 500° C., in isobutene, a maximum sensitivity at a temperature of 300° C. to 400° C. and in carbon monoxide, a maximum sensitivity at a temperature of 100° C. to 200° C. Though the oxide semiconductor element is heated to a temperature condition of 250° C. to 500° C. by pulsed energization to the heating element of this example and becomes high in resistance, the temperature starts to decrease gradually and is balanced toward an ambient temperature after the energization to the heating element is completed. When a temperature in detecting the resistance between the pectinate electrodes is set at a temperature at which the element has a maximum sensitivity to the gas to be detected, a highly sensitive detection of an objective gas becomes possible.

Thus, it becomes possible to detect two or more kinds of gases simultaneously by combining the solid electrolyte element formed on the insulating coating with the oxide semiconductor element. The combination of a characteristic of the solid electrolyte element and a characteristic of the oxide semiconductor element allows making use of the both advantages effectively while complementing each weak point. It becomes also possible to determine a composition of a mixture gas by preparing a regression equation previously on a mixture gas and combining these two elements to solve simultaneous equations. Though there is a method to be intended to detect two or more kinds of gases, using the difference between the temperature sensitivities of the oxide semiconductor elements, only by the oxide semiconductor element, it is difficult to enhance the selectivity of gas in this method. For example, the temperature of the element needs to be set at a low temperature of 50° C. to 100° C. in order to enhance the selectivity with respect to the detection of carbon monoxide but at these temperatures, the possibility of wrong alarms due to miscellaneous gases like alcohol or the risk of wrong alarms due to water vapor arises. On the contrary, the constitution of this example has little risk of wrong alarms like this because it is operated on the high-temperature side.

In the gas sensor of this example, there is little difference in efforts concerning processes to fabricate the gas sensor between the constitution of single solid electrolyte element and that of two or more solid electrolyte elements. Thus, it is possible to realize a gas sensor with high reliability and low price.

### Example 6

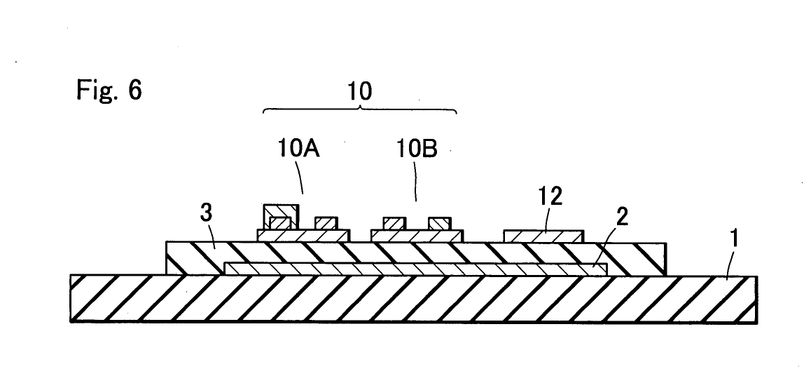

FIG. 6 is a sectional view illustrating the constitution of a gas sensor of example 6 of the invention. As shown in FIG. 6, a gas sensor of this example 6 is constructed by forming a plurality of electromotive force type gas sensor sections 10A, 10B and a resistance film 12 with an insulating film interposed on the insulating substrate 1, on which a heating element 2 is provided. The acts and effects of two or more electromotive force type gas sensors are similar to that of the previous example 4. In a gas sensor of example 6 constructed as described above, the simultaneous detection of carbon monoxide and other various reducing gases and the operations with high reliability as a gas sensor become possible. The resistance film 12 can be formed using the same platinum base metal thin film as the heating element 2 and a resistance value is set at a reference value at a specific temperature by being formed into a predetermined pattern. Thereby, the temperature of the resistance film can be measured based on the intrinsic resistance temperature coefficient of the resistance film 12 and the measured resistance of the resistance film in this example 6. Though the temperature of the electromotive force type gas sensor sections is raised to an operation temperature in a short time by pulsed energization to the heating element 2, it is cooled by heat radiation when the power input is interrupted, and for example in the case where the time period of the pulse energization is at a level of 10 milliseconds, effects of the increase in temperature through the energization to the heating element almost disappear in about one second and a temperature of the resistance film 12 becomes a temperature illimitably close to an ambient temperature for this interruption of the power input. When in this situation, a temperature of the resistance film is measured, measurement of an ambient temperature becomes possible. Thereby, it is possible to notify the fire based on this temperature of the resistance film when the fire occurs to cause a rapid temperature increase. And, though smoke or carbon monoxide is generated in addition to the change in temperature in the event of the fire, in the gas sensor of this example 6, it is possible to notify the fire accurately by unifying information of the fire and a carbon monoxide sensor since the concentration of carbon monoxide can be sensed with high precision. Since in this gas sensor, it is possible to manufacture sensors at one go by applying micro-processing process technique on one substrate, sensors with high reliability can be manufactured at low cost and in large quantity.

### Example 7

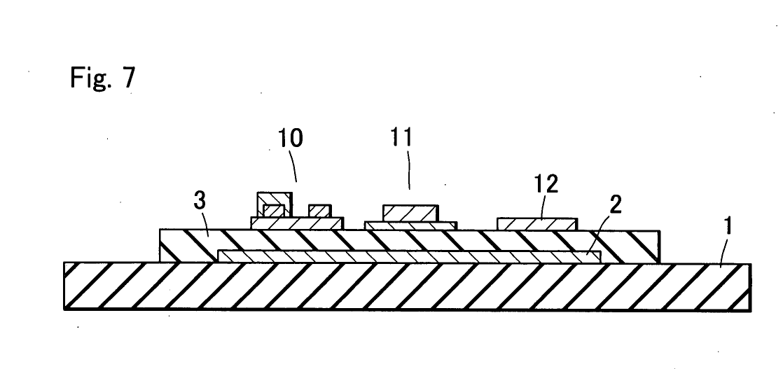

FIG. 7 is a sectional view of a gas sensor of example 7 of the invention. As shown in FIG. 7, a gas sensor of example 7 is provided with an electromotive force type gas sensor section 10, a semiconductor type gas sensor section 11 and a resistance film 12 with an insulating film 3 interposed on the heat-resistant glass base substrate 1 in the form of a plate, on which a heating element 2 is provided. This example 7 is the combined sensor of that of example 5 and that of example 6. The basic operations and functions are similar to those of the previous examples.

In this example, it is possible to perform the simultaneous detection of two or more kinds of gases with a high degree of reliability and in addition it becomes possible to notify the fire with less risk of wrong alarm and with a high degree of reliability by providing three kinds of sensors, i.e., the solid electrolyte type gas sensor of electromotive force type, the semiconductor type gas sensor and the temperature sensor on the substrate and by combining information of these sensors effectively. Though the gas sensor is one thus integrated, multiple gas sensors, which are of low cost and have stable performances, can be supplied in accordance with this example 7 since a process for manufacturing sensors is less different from that of manufacturing a single-function sensor.

### Example 8

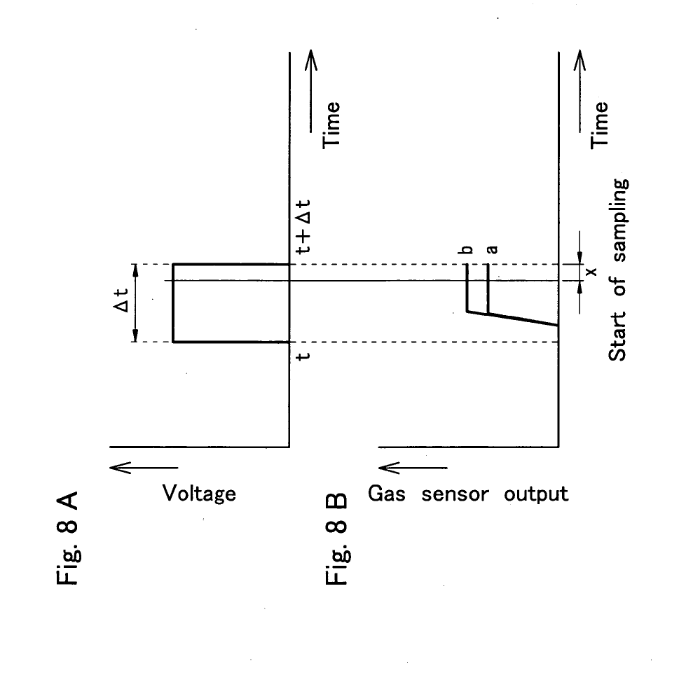

FIG. 8 are graphs showing an example on a way of collecting data in a method of sensing the gas concentrations of the present invention. FIG. 8A shows a voltage input applied to the electromotive force type gas sensor. This shows that voltage is applied to the heating element section for the duration of ΔT from arbitrary t-time. In FIG. 8A, there is shown the case where a constant voltage is input. Since the inrush power load becomes large when the constant voltage is input, desirably, the power to be input is adequately controlled in actual fact in such a way that such a load does not become large and input. Herein, the descriptions of such a control are omitted for simple explanations.

FIG. 8B is a graph showing a electromotive force presented between a pair of electrodes of the electromotive force type gas sensor in the form of being capable of a comparison with a voltage applied to the heating element of FIG. 8A. This may be applied similarly for the case of forming porous oxidation catalyst on one electrode using a pair of same electrodes, the case of combining a first and a second electrodes which are mutually different and also the case of forming porous oxidation catalyst on one electrode of different electrodes. That is, the output of the electromotive force between the electrodes does not appear at the initial stage when voltage is applied to the heating element and heating is started because temperature is still low at this stage. After a time has elapsed, power energy to the heating element effects a temperature increase of a main portion of the electromotive force type gas sensor and the gas sensor output presents itself at a certain timing. A state in which the gas sensor output presents itself starts from the moment when heating proceeds and the electromotive force type solid electrolyte gas sensor becomes active. This output starts to exhibit a substantially stable value of equilibrium at a certain time. Incidentally, the output does not exhibit the value of equilibrium and increases further under certain circumstances.

The moment preceding time t+ΔT by time X is a starting time of sampling of data of the electromotive force output. Though this moment lies within a duration of energization in this Figure, the moment may be the case where a minute time elapsed after the completion of time t+ΔT. Data sampling is determined to do at an arbitrary from this time t+ΔT−X determined. By applying the pulsed voltage to the heating element and performing the sampling repeatedly at predetermined timing within each heating duration of ΔT like this, discontinuous and discrete output values can be obtained.

By the way, when the gas to be detected like carbon monoxide is not produced, a time-average of the electromotive force output at an arbitrary measuring time within a range from time t+ΔT−X to time t+ΔT shows values expressed by a symbol “a”. In this Figure, since the output reaches an equilibrium state, the average is a. And each discontinuous and discrete value also become a value obtained by lining this discontinuously. On the other hand, when carbon monoxide is produced, a time-average of the electromotive force output becomes similarly “b”. Each discontinuous and discrete value varies from “a” to “b” according to the number of data taken.

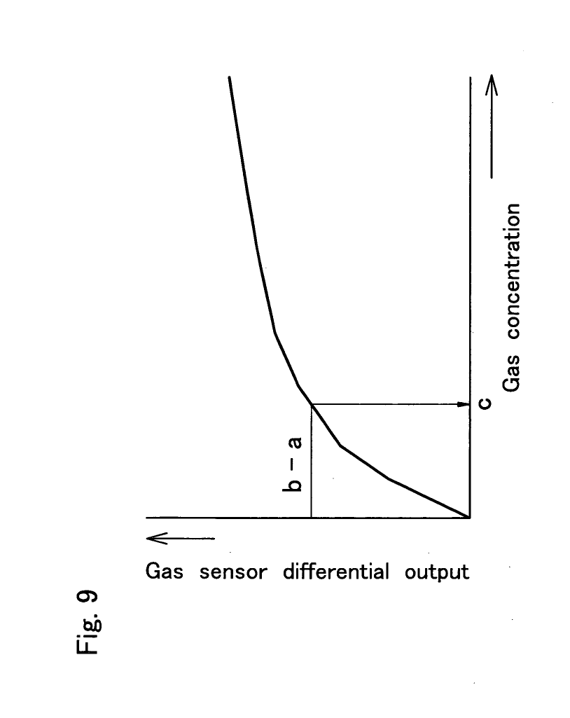

Here, in the gas sensor of example 1, the output corresponding to “a” is zero (0), and in the gas sensor of example 2, the output corresponding to “a” takes a value other than zero. In FIG. 9, there is shown a differential output (b−a) of a gas sensor on the gas concentrations. When such a relation between the output and the gas concentrations is previously stored in a memory, an objective gas concentration can be known by using the differential output (b−a) obtained from the electromotive force type gas sensor.

### Example 9

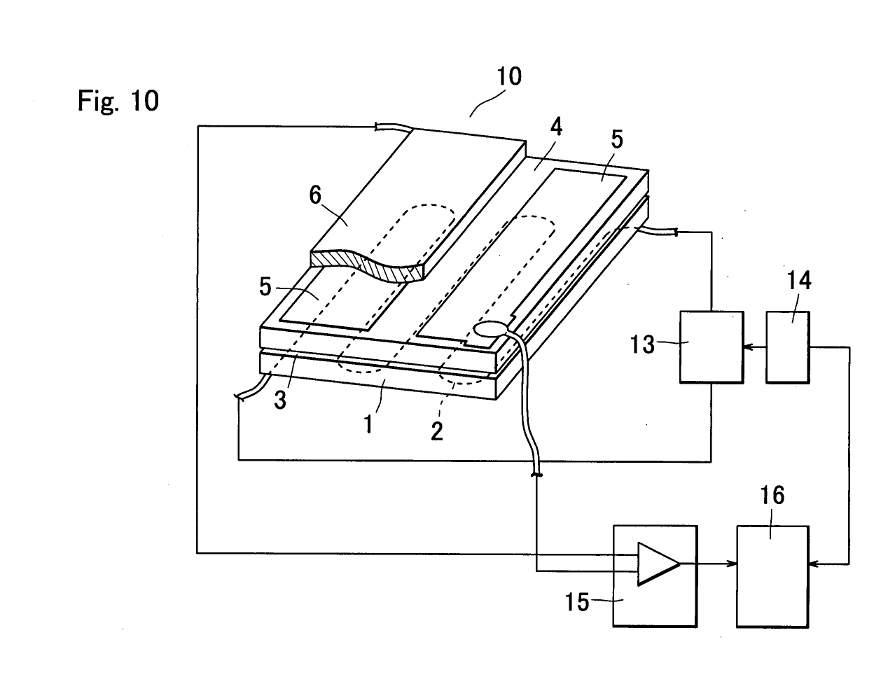

FIG. 10 is a constitution diagram of an apparatus for sensing the gas concentrations of the present invention. In FIG. 10, reference numeral 10 denotes an electromotive force type gas sensor. The electromotive force type gas sensor 10 is constructed by forming the solid electrolyte layer 4 with the insulating layer 3 interposed on the heat-resistant glass base substrate 1, including the heating element 2, in the form of a plate and by forming a pair of electrodes 5 on the solid electrolyte 4 and further forming a layer of porous oxidation catalyst 6 on one electrode thereof. In FIG. 10, as the electromotive force type gas sensor 10, there is shown an element provided with a pair of electrodes 5 on the solid electrolyte 4 and a layer 6 of porous oxidation catalyst on one electrode of a pair of electrodes, but a pair of electrodes may be replaced with a second electrode which is different from a first electrode. In this case, the gas sensor may not necessarily include the layer 6 of porous oxidation catalyst.

Reference numeral 13 denotes a power supply means of supplying electric power to the heating element 2 of the electromotive force type gas sensor 10. The power supply means 13 is a power supply circuit for supplying electric power to the heating element. The power supply means includes the voltage transformation function of boosting the voltage of a power supply like a battery to the voltage matching the resistance of the heating element. And, reference numeral 14 denotes a power control means of controlling the power supply means. The power supply means 13 is controlled by the power control means 14 in such a way that the resistance of the heating element becomes a target set point through an adjustment of a voltage and a current applied to the heating element 2. And, the power supply means 13 is controlled so as to repeat periodically a pulse boot energization operation and a stop operation by the power control means 14. Further, the power control means 14 plays also a role in controlling the power supply means 13 in such a way that the pulse boot operation does not give a significant heat shock to the electromotive force type gas sensor element and does not cause a detection means 15 of the electromotive force signals to produce noise.

A periodical and intermittent pulsed power is input to the heating element 2 by the power supply means 13 and the power control means 14 and the electromotive force type gas sensor 10 becomes an operable standby condition.

Thus, the output of the electromotive force, which corresponds to the level of gas concentrations in the ambient where the electromotive force type gas sensor is placed, is generated from a pair of electrodes 5 of the electromotive force type gas sensor 10. This output of the electromotive force is amplified by the detection means 15 of the electromotive force signals. The electrode on the side where the porous oxidation catalyst 6 is provided becomes a reference electrode and is usually positive because of being on the side of a high concentration of oxygen, and the other electrode is a negative side. In the detection means 15 of the electromotive force signals, signals between both electrodes are received at the differential operational amplifier and amplified. Since the output signals of the electromotive force is high in the impedance, the differential operational amplifier receiving the output also requires the specification of high impedance. And, the detection means 15 of the electromotive force signals may have a constitution in which using a pair of operational amplifier connected to an earth line on one side, the amplified output from the operational amplifier is further input into a differential operational amplifier.

Thus, the output signals of the electromotive force from the electromotive force type gas sensor 10 is amplified. The output signals of the electromotive force based on the operation by pulsed driving receives timing signals from the power control means to take an average of the electromotive force output of required time at a timing required for a signal control means 16 into the signal control means 16. The signal control means is a microcomputer and taken in the time series signal output of the electromotive force type gas sensor to store in the operation by pulsed driving. The memory values taken in are utilized for communications, generating alarms or some controls as required.

### Example 10

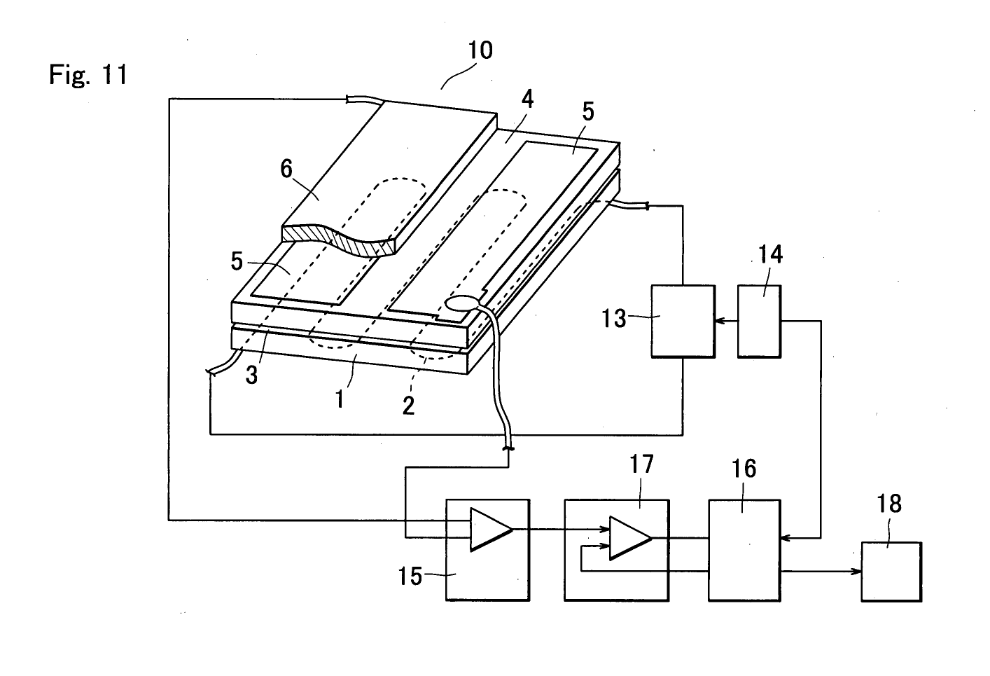

FIG. 11 is a constitution diagram of an apparatus for sensing the gas concentrations of the present invention. In the constitution of FIG. 11, a comparison means 17 comparing signals with a reference value of electromotive force output signals and an alarm means 18 are newly provided in addition to the constitution of FIG. 10. The operations are similar to that of the previous example 9 in partway. The comparison means 17, which the apparatus for sensing the gas concentrations of the invention is newly provided with, includes a differential operational amplifier and the like and compares the output signals from an amplification means 15 of the electromotive force signals with the target value of the gas concentration, which is previously set in the microcomputer 16, to send signals to an alarm means 18 at a command of the microcomputer and to emit audible alarms through alarming and light alarms by liquid crystal and LED when the gas concentrations exceed the set point.

Hereafter, there is described test data on the prototype of the gas sensor of the invention.

(Prototype Sensor 1)

Quartz substrate 2 mm square with a plate thickness of 0.5 mm was used as a substrate, patterning was applied to a central area 0.5 mm square thereon with a film thickness of 0.5 μm through sputtering and chromium thin film with a film thickness of 100 Å was formed by patterning, and then platinum resistance film having resistance of 20 Ω was formed and further silica coating with a film thickness of 2 μm was formed in an area 1 mm square on the surface thereof as an insulating film by sputtering. Under this condition, aging was performed at 600° C. for 2 hours to stabilize the coating. This aging resulted in the resistance of about 10 Ω. The solid electrolyte film was formed thereon. The solid electrolyte film was formed with a film thickness of about 2 μm by patterning yttrium stabilized zirconium (8Y article) being an oxygen ionic conductor with a dimension of 0.4 mm×0.6 mm and sputtering. Further, after a pair of platinum electrodes, each of which has a film thickness of 0.5 μm and a dimension of 100 μm×50 μm, were formed on the solid electrolyte film similarly by sputtering, the coating was stabilized by aging at 600° C. for. 12 hours. A porous oxidation catalyst coating having a dimension of 150 μm×70 μm was formed with a sintered film thickness of about 10 μm on one electrode of the element, using γ alumina sol base paste containing platinum and palladium in amounts of 1 wt. %, respectively. Platinum leads were joined to these electrodes and the leads were welded to nickel pins to form a sensor.

As comparisons, two elements in which a substrate was alumina (prototype element 1-2) and a groundwork was not applied (prototype element 1-3) were prepared.

(Prototype Sensor 2)

Coating was prepared as in the case of the prototype sensor 1 up to a preparation of the substrate and a formation of the solid electrolyte, and one electrode of a pair of electrodes was formed using perovskite type complex oxide of LaCoO₃ and other electrode was formed using perovskite type complex oxide of LaMnO₃. After these electrodes were formed with a film thickness of about 10 μm by a thick-film print process, these were dried and sintered at 600° C. for 1 hour to form electrodes. Platinum leads were joined to these electrodes and the leads were welded to nickel pins to form a sensor.

(Prototype Sensor 3)

Quartz substrate 3 mm square with a plate thickness of 0.5 mm was used as a substrate, and after chromium groundwork coating with a thickness of 50 Å was formed, patterning was further applied to a central area 0.5 mm square thereon with a film thickness of 0.5 μm through sputtering to form platinum resistance film having resistance of 20 Ω and further silica coating with a film thickness of 2 μm was formed in an area 1 mm square on the surface thereof as an insulating film by sputtering. Under this condition, aging was performed at. 600° C. for 2 hours to stabilize the coating. This aging resulted in the resistance of about 10 Ω. Further, two solid electrolyte coating patterns with a dimension of 0.2 mm×0.5 mm were formed at a location corresponding to a heater film on the aged coating. These two solid electrolyte coating patterns were spaced with a distance of 100 μm from each other (in such a way that the portion of the spacing of 100 μm is positioned at the midsection of the substrate) to be formed.

The two solid electrolyte films were formed with a film thickness of about 2 μm by patterning yttrium stabilized zirconium (8Y article) being an oxygen ionic conductor with the above-mentioned dimension and sputtering. Further, after a pair of electrodes, each of which has a film thickness of 0.5 μm and a dimension of 100 μm×50 μm, were formed on each above-mentioned sputtering film (solid electrolyte film) similarly by sputtering, the coating was stabilized by aging at 700° C. for 1 hour. For each solid electrolyte element, a porous oxidation catalyst coating having a dimension of 150 μm×70 μm was formed with a sintered film thickness of about 10 μm on one electrode of a pair of electrodes, using γ alumina sol base paste containing platinum and palladium in amounts of 1 wt. %, respectively. Platinum leads were joined to these electrodes and the leads were welded to nickel pins to form a sensor.

(Prototype Sensor 4)

The same substance was used as a substrate and two solid electrolyte coating patterns were prepared following the same procedure as the case of the prototype sensor 3, and a pair of electrode films were formed using the same pattern and different film thickness. That is, one electrode was formed with a film thickness of 0.5 μm like the element 1 and other electrode was formed with a film thickness of 1.2 μm, and in another processes the same constitution as the prototype element 1 was used to form a gas sensor.

(Prototype Sensor 5)

The same substance was used as a substrate and two solid electrolyte coating patterns were prepared following the same procedure as the case of the prototype element 3, and electrode films were also formed using the same pattern and different material. That is, though the both film thickness of the respective electrodes were 0.5 μm, an electrode of one element was formed by patterning a platinum electrode through sputtering and an electrode of other element was formed by patterning an electrode of perovskite oxide of LaCoO₃, respectively, through sputtering. Another processes were performed as in the case of the prototype element 1 to form a gas sensor.

(Prototype Sensor 6)

The same substance was used as a substrate and two solid electrolyte coating patterns were prepared following the same procedure as the case of the prototype sensor 3, and then the same procedure as the prototype sensor 3 was followed up to the formation of electrode films. For one solid electrolyte element, a porous oxidation catalyst coating having a dimension of 150 μm×70 μm was formed with a sintered film thickness of about 10 μm on one electrode of a pair of electrodes, using γ alumina sol base paste containing platinum and palladium in amounts of 1 wt. %, respectively, and for the other solid electrolyte element, a porous oxidation catalyst coating having a dimension of 150 μm×70 μm was formed with a sintered film thickness of about 10 μm on one electrode of a pair of electrodes, using γ alumina sol base paste containing LaCoO₃ in an amount of 5 wt. %. Platinum leads were joined to these electrodes and the leads were welded to nickel pins to form a sensor.

(Prototype Sensor 7)

The same substance was used as a substrate and two solid electrolyte films were prepared following the same procedure as the case of the prototype sensor 1. And, a pair of platinum electrodes with a film thickness of 0.5 μm were formed on one solid electrolyte film, and the solid electrolyte element was constructed by forming a porous oxidation catalyst on one electrode of a pair of electrodes and on other solid electrolyte film, a pectinate platinum electrode was formed in an area with a dimension of 0.2 mm×0.5 mm with a film thickness of 0.5 μm and tin oxide coating was formed with a film thickness of about 2 μm by sputtering to form a gas sensor having a constitution in which palladium corresponding to 0.5 wt. % was supported on the surface.

With respect to the respective sensor prototypes described above, for the prototype sensor 1, a flow type test apparatus was used, the gas sensor element was accommodated in a mesh case, a surrounding temperature was set at an ambient temperature, the mesh case was accommodated in a box having a volume of 10 l(1), carbon monoxide gas was flown under the atmospheric condition, the gas sensor was energized for a duration of 10 milliseconds once every 30 seconds and controlled by a temperature of the heating element in such a way that the operation temperature was 450° C., and an average output value for a duration of 100 microseconds since after a lapse of 9.9 milliseconds from the start of energization was measured.

All the prototype sensor 2 and the following prototype sensors were tested in the flow type test apparatus. That is, test gases were flown under the atmospheric condition, the gas sensors were energized for a duration of 10 milliseconds once every 30 seconds and controlled by a temperature of the heating element in such a way that the operation temperatures were 450° C. (350° C. for test 2), and average output values for a duration of 100 microseconds since after a lapse of 9.9 milliseconds from the start of energization were measured. Results of evaluation of the output characteristic of the sensors are shown in Table 1. Among respective prototype sensors, as for the solid electrolyte elements, the electromotive force outputs were measured as it is, and as for the oxide semiconductor elements, the outputs were measured by converting the changes in resistance to voltages. And, with the oxide semiconductor elements, the outputs were measured at the same timings in measuring methane and at the moment when the elements were cooled to 350° C. in measuring isobutane.

(Evaluation of Prototype Sensor 1)

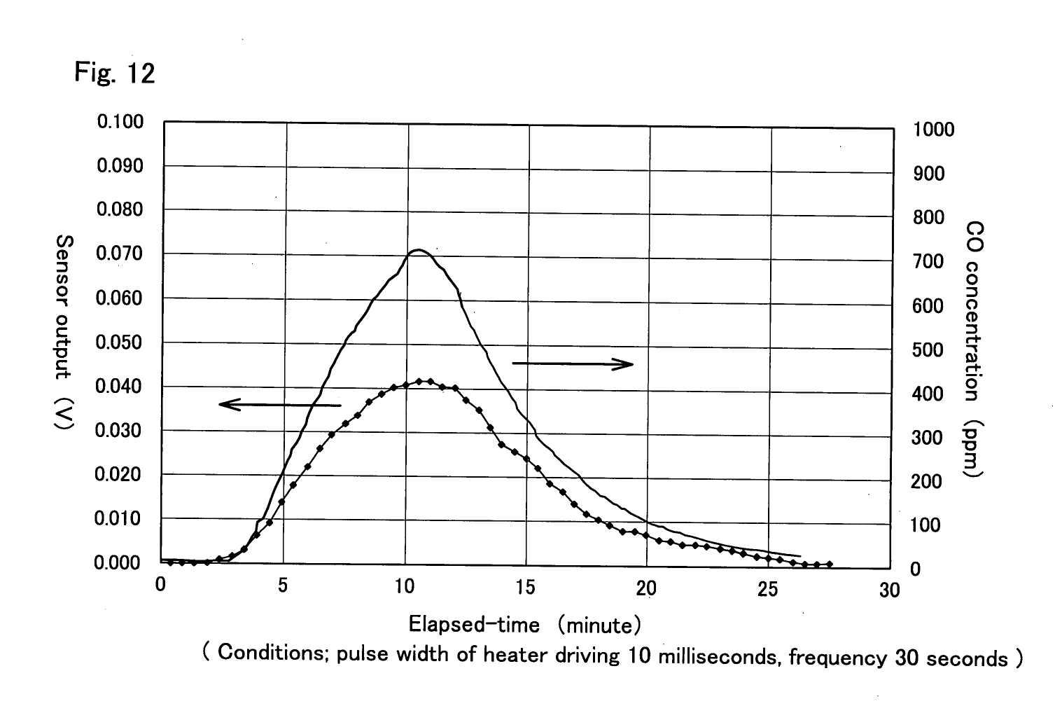

The characteristics of pulsed driving of the prototype gas sensor 1 is shown in FIG. 12. One characteristic indicates the concentration of carbon monoxide and the other one indicates the output of the prototype gas sensor 1. This power consumption was about 0.4 mW.

As for comparison element 1-2, when a duration of a pulsed operation is set at 0.3 second or less, a substrate was broken and the element could not perform the pulsed operation. And, as for comparison element 1-3, resistance value increased with the number of pulsed operations and became infinite at the point of pulsed operations of one hundred and eighty thousands.

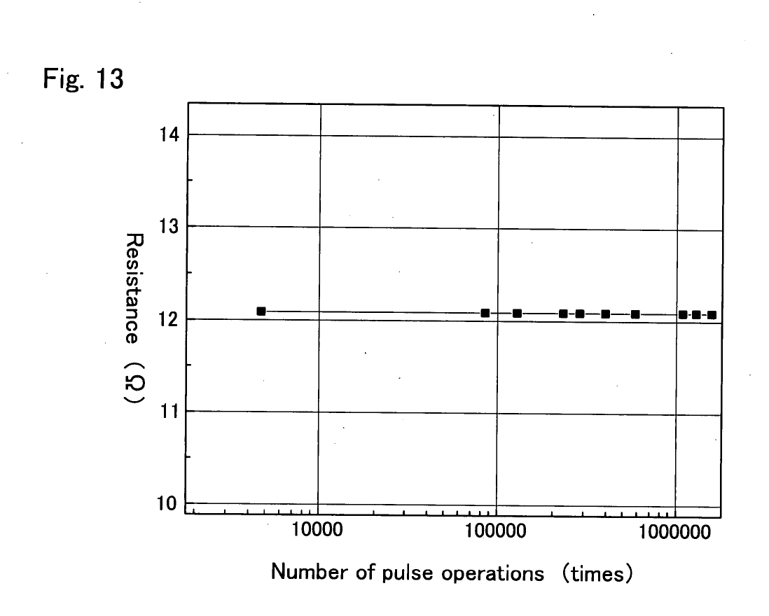

In FIG. 13, there is shown the relation between the number of pulsed energization operations and the resistance of the prototype gas sensor. In this prototype, the changes of resistance are not recognized at all within a test range of up to three million times.

(Evaluation of Prototype Sensor 2)

With respect to the prototype sensor 2, the output was measured while flowing carbon monoxide in concentration of 100 ppm, and the output of about 18 mV was recognized. Further, this gas sensor hardly has sensitivity to carbon monoxide at 400° C. and on the contrary shows a high output of 25 mV for methane with the concentration of 0.5%.

(Evaluation of Prototype Sensor 3)

With respect to the prototype sensor 3, the output was measured while flowing carbon monoxide in concentration of 500 ppm, and the outputs of 20.5 mV on one electrode and 23.5 mV on the other electrode were obtained. These outputs summed to the output of 44 mV to obtain a highly sensitive sensor output.

(Evaluation of Prototype Sensor 4)

With respect to the prototype sensor 4, the output was measured at an early stage while flowing similarly carbon monoxide in concentration of 500 ppm, and the outputs of 19.6 mV on the element 1 and 5.3 mV on the element 2 were obtained. Next, with respect to this sensor, sulfur dioxide gas was flown in, concentration of 100 ppm for 100 hours and then the similar test was performed, and consequently the output of the element 1 decreased to 12.2 mV but the outputs of the element 2 did not vary. If by using a ratio of the sensor output of the element 1 to that of the element 2, the output of the element 1 is corrected and an alarm signal is generated after the output of the element 1 decreases, decrease in the sensitivity can be corrected even though the element with a high sensitivity decreased in sensitivity.

(Evaluation of Prototype Sensor 5)

With respect to the prototype sensor 5, for test 1, carbon monoxide was alone flown in concentration of 500 ppm and for test 2, hydrogen alone in concentration of 250 ppm and for test 3, the mixture gas of both gases is flown, and the outputs were measured.

TABLE 1
Test results of prototype sensor 5 (sensor output: mV)

| | Output of element 1 | Output of element 2 |
|---|---|---|
| Test 1 | 21.9 | 15.8 |
| Test 2 | 12.2 | 2.2 |
| Test 3 | 30.8 | 16.5 |

Though there is not necessarily the additivity of output, since the element 2 has a high selectivity to carbon monoxide with respect to the mixture gas of test 3, it is expected that carbon monoxide is contained in an amount of about 500 ppm from the output of the element 2 and that hydrogen is contained in an amount of about 250 ppm by performing an operation based on a regression equation from the output of the element 1. Though the element l happens to exhibit extremely high selectivity, a composition can be estimated by performing an operation conversely simultaneous equations based on each regression equation even in an element not having such a high selectivity as the element 2.

(Evaluation of Prototype Sensor 6)

With respect to the prototype sensor 6, for test 4, carbon monoxide was alone flown in concentration of 500 ppm and for test 5, methane alone in concentration of 2000 ppm and for test 6, the mixture gas of both gases is flown, and the outputs were measured.

TABLE 2
Test results of prototype sensor 6 (sensor output: mV)

| | Output of element 1 | Output of element 2 |
|---|---|---|
| Test 4 | 22.8 | 12.5 |
| Test 5 | 2.2 | 15.5 |
| Test 6 | 22.9 | 25.5 |

Though methane is difficult for oxidizing and concentration, dispersion state and matching with a support of a catalyst concern the oxidation of methane in the platinum-group catalyst of the element 1 and the perovskite type complex oxide catalyst of the element 2, it is considered that the element 1 becomes a catalyst being noticeable in oxidation ability of carbon monoxide and the element 2 becomes a catalyst being noticeable in oxidation ability of methane and such a difference presents itself as a difference between sensor outputs. Also with this sensor, by using deviations of the output characteristics of carbon monoxide and methane relative to the mixture gas in the elements 1 and the element 2, the compositions of the mixture gas can be determined as in the case of the prototype sensor 5.

(Evaluation of Prototype Sensor 7)

With respect to the prototype sensor 7, the solid electrolyte side showed an output of about 24 mV for carbon monoxide of 500 ppm. On the other hand, the oxide semiconductor side showed the change in resistance 80 times more than air for methane of 2000 ppm. Further, this showed also the change in resistance 115 times more than air for isobutane of 2000 ppm. And, for the mixture gas of test 6, the element 1 showed an output of about 24 mV and the element 2 showed the change in resistance 85 times more than air. It is conceivable that the reason for this is that the element 2 has the sensitivity to carbon monoxide a little. Thus, the compositions of the mixture gas can be determined.

The multiple gas sensor of the present invention is embodied in such an aspect as described above and attains the following effects:

1) since it is essentially constructed with the structure in which functional films are stacked on the substrate in the form of a plate, micro-processing technique established in the manufacturing processes of semiconductor is applicable and sensors having stable quality characteristics can be manufactured at low cost and in large quantity;

2) it is possible to realize a multiple sensor, in which several kinds of functions of gas sensor are integrated on one substrate, at low cost;

3) since it allows an alarm operation which consolidates the sensor function of notifying the fire and the sensor function of carbon monoxide and complements each other, it is possible to construct a safe sensor system which has a high reliability of notifying and can be used with a safe conscience;

4) it is possible to attain the high detecting sensitivity and to detect gas with a high degree of reliability by summing the sensor outputs of the multiple elements for gas to be detected;

5) it is possible to avoid substantially the decrease in the sensitivity in using a sensor during an extended period of time by correcting the decrease in the sensitivity of the sensor with a high sensitivity based on the characteristic of the sensor having a stable characteristic on the problems of the decrease of output associated with degradation of sensor functional section in using during an extended period of time, which have been issues of conventional gas sensors, i.e., the problem of being not fail safe;

6) it is possible to perform the extremely reliable double-detection for notifying the fire and incomplete combustion as a safety sensor; and

7) it has features that it is a compact and power-saving type and low in power consumption as a multiple sensor.

As described above, in accordance with the present invention, it is possible to attain a highly practical sensor which resolves significantly the issues of conventional safety sensors for ordinary households as a multiple sensor.

1. A gas sensor comprising;
a substrate and,
an electromotive force type gas sensor element having a heating element on said substrate, an insulating layer on said heating element, a layer of solid electrolyte on said insulating layer, and two electrodes on the layer of solid electrolyte,
wherein said substrate being a heat-resistant glass base substrate.

2. The gas sensor according to claim 1, further comprising a porous oxidation catalyst layer on one of said two electrodes.

3. The gas sensor according to claim 2, wherein said two electrodes are made of materials identical with each other.

4. The gas sensor according to claims 1 or 2, wherein said two electrodes are a first electrode and a second electrode which are mutually different in the oxygen adsorption capacity.

5. The gas sensor as in one of claims 1 to 4, wherein said heat-resistant glass base substrate is one selected from the group consisting of quartz substrate, crystalline glass substrate and glazed ceramic substrate.

6. The gas sensor as in one of claims 1 to 5, wherein said heating element is a platinum base metal thin film.

7. The gas sensor according to claim 6, further comprising a Ti thin film or a Cr thin film having a thickness in a range of 25 Å to 500 Å between said heat-resistant glass base substrate and said heating element.

8. The gas sensor as in one of claims 1 to 7, comprising two or more said electromotive force type gas sensor elements on the substrate.

9. The gas sensor as in one of claims 1 to 8, further comprising a resistance film for detecting temperature on the substrate.

10. The gas sensor as in one of claims 1 to 10, further comprising a semiconductor type gas sensor element on the substrate.

11. A method of sensing the gas concentrations with a gas sensor element which includes a heating element and which is capable of outputting signals corresponding to the gas concentration detected at a predetermined temperature, said method comprising:
a step of bringing a temperature of the gas sensor element to a predetermined temperature or higher at least for a definite time of period straddling the time of interruption of the pulsed voltage by applying a pulsed voltage to the heating element periodically; and
a step of detecting signals output by the gas sensor element within the definite time of period.

12. The method of sensing the gas concentrations according to claim 11,
wherein said gas sensor element is an electromotive force type gas sensor element provided with a solid electrolyte layer and a first electrode and a second electrode on said solid electrolyte layer, respectively, said first and second electrodes being different in the oxygen adsorption capacity,
wherein an electromotive force differential between the first electrode and the second electrode is detected as the signal corresponding to the gas concentration which is output from the gas sensor element in the step of detecting.

13 The method of sensing the gas concentrations according to claim 11,
wherein said gas sensor is an electromotive force type gas sensor element provided with a solid electrolyte layer, a pair of electrodes formed on the solid electrolyte layer, and a porous oxidation catalyst layer on the one of said pair of electrodes,
wherein a potential of the one electrode relative to the other electrode is detected as signals corresponding to the gas concentration output from the gas sensor element in the step of detecting.

14. A gas detecting apparatus comprising;
a heat-resistant glass base substrate provided with a heating element,
an insulating layer on the heat-resistant glass base substrate,
an electromotive force type gas sensor on said insulating layer
a power supply means which supplies electric power to said heating element,
a power control means of controlling the power applied to said heating element,
a detection means of the electromotive force signals of the gas sensor and,
a signal control means.

15. A gas detecting apparatus comprising;
a heat-resistant glass base substrate provided with a heating element,
an insulating layer on the heat-resistant glass base substrate,
an electromotive force type gas sensor on said insulating layer
a power supply means which supplies electric power to said heating element,
a power control means of controlling the power applied to said heating element,
a detection means of the electromotive force signals of the gas sensor,
a signal control means, and
an alarm-notifying means alarming in recognizing with a comparison means that the concentration of the gas to be detected is equal to or higher than the predetermined reference concentration.
